(19) United States
(12) Patent Application Publication
(10) Pub. No.: US 2004/0003266 A1
(43) Pub. Date: Jan. 1, 2004

(54) Non-invasive automatic offsite patch fingerprinting and updating system and method

(75) Inventors: Sean Moshir, Scottsdale, AZ (US); Christopher A.H. Andrew, Chandler, AZ (US); Jonathan M. Gordon, Mesa, AZ (US); Michael Bacon, Peoria, AZ (US)

Correspondence Address: JOHN W L OGILVIE, COMPUTER LAW, 1211 EAST YALE AVE, SALT LAKE CITY, UT, 84105, US

(73) Assignee: PatchLink Corporation

(21) Appl. No.: 10/394,447

(22) Filed: Mar. 20, 2003

Related U.S. Application Data
(63) Continuation-in-part of application No. 09/957,673, filed on Sep. 20, 2001.
(60) Provisional application No. 60/234,680, filed on Sep. 22, 2000.

(51) Int. Cl. G06F 11/30; G06F 9/44; G06F 9/445

(52) U.S. Cl. 713/191; 717/168; 717/174

(57) ABSTRACT

Methods, systems, and configured storage media are provided for discovering software updates, discovering if a given computer can use the software update, and then updating the computers with the software as needed automatically across a network without storing the updates on an intermediate machine within the network. Furthermore, when a failure is detected, the rollout is stopped and the software can be automatically removed from those computers that already were updated. The software update can be stored originally at an address that is inaccessible through the network firewall by intermediately uploading the software update to an update computer which is not a part of the network but has access through the firewall, which is then used to distribute the update.

### RELATED APPLICATIONS

This application is a continuation-in-part of U.S. patent application Ser. No. 09/957,673 filed Sep. 20, 2001, which in turn claims priority to, and incorporates by reference, provisional patent application serial No. 60/234,680 filed Sep. 22, 2000.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The copyright owner does not hereby waive any of its rights to have this patent document maintained in secrecy, including without limitation its rights pursuant to 37 C.F.R. §1.14.

### FIELD OF THE INVENTION

The present invention relates to systems and methods which update existing software across a remote network. The invention relates more specifically to checking for the need for updating and then updating the software as required across a client-server system without the need for human oversight, and without requiring that a target network administrative machine keep copies of software patches.

### TECHNICAL BACKGROUND OF THE INVENTION

The ‘state of the art’ in the computer software industry remains such that software is often delivered with various anomalies in its desired behavior. These anomalous behaviors have come to be called “bugs”.

The original computer bug is in the operations log of the Harvard University Mark II Aiken Relay Calculator, now preserved in the Smithsonian. The operators removed a moth that had become trapped between relay switches in the computer, and wrote the entry “First actual case of bug being found.” Problems with computer hardware and software have since been called “bugs”, with the process of removing problems called “debugging”.

Each time software is “debugged”, a change to that piece of software is created—this change sometimes results in an additional piece of software called a “patch” or “fix”. The industry's software vendors often call these patches by the more formal names “Service Packs” or “Support Packs.”

This process has become so prevalent in the industry that software vendors use various naming and numbering schemes to keep track of their available “Support Packs”. The difficulty of keeping these “Support Packs” straight is increased when vendors fail to agree on a standard scheme of naming and numbering.

Microsoft, for instance, for its Windows NT family of operating system software products has no less than six major “Service Packs” available to be applied to solve problems its customers may experience. More generally, the total number of patches, fixes, solutions, and/or service packs for any given operating system may be enormous.

When an application is installed, it may contain one or more of these operating systems file patches along with the standard computer files. The patches are generally included because the application vendor discovered some anomalous behavior in one or more of the operating system files, and so sent a “fix” in the form of a different version of one of these troublesome files. This would cause relatively little difficulty if only one application vendor performed this service, or if the file modified by the application vendor is used only by that vendor's application. However, this is often not the case.

When another application is installed, that application may include a more recent version of a shared piece of code. One subset of these shared operating system files are called DLL's (dynamically linked libraries), though they also go by other names. These shared operating system files are often executable, and they expect a fixed number of parameters, certain kinds of parameters, and so on. If the nature of the shared file has changed (e.g., the parameter set is different, the name is different, the function is different), the calling application may no longer behave correctly. Many common computer functions such as “print” are referenced in this fashion.

Many software vendors try to provide the “latest” version of the operating system file. However, when a different application is loaded onto a computer, it may overwrite and subtly (or not-so-subtly) change an operating system file that the original application needed to function as planned.

Assume an administrator for an organization is charged with keeping one hundred servers up and running while supporting three thousand users connecting to these servers. The administrator is also responsible for installing user requested or management dictated applications—either shrink wrapped purchases or internally developed applications. The administrator also has responsibility for the timely distribution, locally or remotely, of time sensitive documents.

Now imagine that six service packs must be installed on the network and distributed to all of the clients. Applying the six service packs could easily result in seven visits to each and every one of the hundred servers for a total of seven hundred visits. This number assumes one extra visit per machine because the application of one of the service packs may cause more problems than it fixed, so it had to be undone.

If the three thousand clients were all running the same workstation operating system, that could mean another twenty-one thousand visits to apply the patches. Remember this all has to be accomplished while installing and patching the internally developed applications and the shrink-wrapped products. Distribution of software patches and files and their subsequent application becomes the first indication of what might be called “administrator agony”.

While all the installation is occurring, the individual servers must still be monitored. When a server needs attention the administrator is often contacted by another person, who may frantically report that their server is down and must be fixed. If the administrator had some method to monitor these devices, he or she could become more responsive and further reduce the impact of problems. Monitoring needs are a second indication of “administrator agony”. There is often high turnover in the administrator's job, and the users of these systems may experience lower productivity.

Traditionally, the administrator had been helped by being given extra staff. Of course this remedy is not without problems—the addition of personnel increases the number of communication channels between them. The people involved in installation and updates need a tracking device or system so they don't perform or attempt to perform the same unit of work. This lack of coordination between team members is a third indication of “administrator agony”.

Proposed solutions are currently available in varying forms, implementations, and coverage or completeness. Typically these proposed solutions are available as shrink-wrap products that are installable (e.g. patchable) locally in the administrator's environment. Some emerging products are helpful, but many conventional solutions are invasive in that they require massive modification of the administrator's environment. The shrink-wrap solution requires additional invasive full product installations in the administrator's network, thereby adding to the problem, and lacks a central “command center” to coordinate the support or distribution plan. Emerging solutions may provide a somewhat lesser degree of invasion, but nonetheless require a special connection between the administrator and the solution, and they often do not provide a center for coordinated efforts.

Furthermore, it is not always obvious exactly what patches, if any, a given piece of software has received. Updates don't always clearly announce their presence. So, it is not always clear whether a specific computer has previously received a specific patch. Accordingly, there is a need for improved tools and techniques for updating computers across a network. Such tools and techniques are described and claimed herein.

### BRIEF SUMMARY OF THE INVENTION

The present invention relates to methods, articles, signals, and systems for determining if software needs updating, and if so, then updating the software across a network with reduced demands on a human administrator. If the update fails, the computer(s) upon which the update software was installed may be restored to a non-updated state. The invention is defined by the appended claims, which take precedence over this summary.

In various embodiments, the invention facilitates software deployment, software installation, software updating, and file distribution based on software and patch finger printing across multiple operating systems and devices, across a network. Any computer with a network connection and with an update agent running on it may connect to an update server, and then process whatever tasks the administrator has designated for that agent.

FIGS. 2 shows an overview of one such system. A network 200, shown with only two target computers and an update computer for simplicity of illustration, is protected from the internet by a firewall 214. The software that is needed to update network target computers 202, 208 resides on package computers 230, 234 that are located inside or outside the firewall and barred by the firewall 214 from direct communications with the target computers 202, 208. However, an update server 220 does have access 216 to the network 200, potentially through internal firewalls—as well as access through the firewall 214. The system is designed to work both as an onsite purchased solution as well as a fully offsite hosted solution, and can operate through firewalls and proxy circuits at any level within the Intranet/Extranet infrastructure.

Patch fingerprints 902 give a recipe to allow a repository component to determine if a given software package (associated with the patch fingerprint), patch, driver, etc. should be loaded onto a computer in the system. These fingerprints are stored in a patch component database location 900 that may be inside or outside the firewall 214. It may be at a separate location or it may be installed on the update server 528. The repository component also includes an inventory library database 918 that contains basic hardware and software information about each of the network target computers 202, 208. Using the information in the patch fingerprint, the inventory library, and specific information gleaned from each network target computer, the system is able to intelligently recommend which patches and drivers are required for a given computer.

As shown in FIG. 5, the preferred embodiment of the invention employs an additional agent known as the discovery agent 548 installed on the target computer 500, which routinely discovers the hardware and software on that machine. This inventory information is then reported back to an inventory library 918 located somewhere else in the repository component. In addition to the computer inventory, the discovery agents also return scan results for patch fingerprints, which indicate whether it is appropriate to install a specific patch associated with each patch fingerprint.

The Inventory Database thus collects a complete inventory of the software, hardware and current patch fingerprints that are installed on any particular target computer within the network. With this information, the update server 528 can present the user with detailed reports of the current patch status for all computers within the network. This illustrates the number of computers needing the patch as well as the computers already installed with the patch.

In addition, Finger Print definitions 906 are also normally associated with an update package suitable for deployment by the system. Once the need for a particular patch has been established by scanning for its signature(s) on all or any computers within the network it can then be quickly deployed by the administrator by merely selecting the date and time.

In some embodiments, fingerprint definitions 906 may be combined with one or more of the following to form a portable patch definition file: vendor bulletin(s) discussing the patch(es), report(s) prepared by embodiments of the invention for administrators, target computer 500 signature(s), deployment package(s). This patch definition file provides information that can be used to update other networks. The patch definition file (a.k.a. “patch metafile”) provides a portable uniform data representation which can be employed by embodiments of the invention to move or replicate patches among update servers 528 of different networks. Suitable networks 100 include without limitation networks that are not connected to the Internet and/or to each other, such as military networks that are isolated to provide greater security. This movement/replication can be done by email, tape write/read, and/or other conventional data transfer means. The patch metafile may also aid the interchange and interoperability of patches between inventive embodiments supplied by different vendors.

The patches that need to be loaded onto specific target computers are listed on the update server 220 in update lists 222 associated with update agents 204, 210; in the illustration, list 224 is associated with Target1 202, and list 226 is associated with Target2 208. The update lists specify at least one location (through means such as a universal resource locator, or URL) where the patch can be found, and optionally include a date which is the earliest date that the software can be installed.

In operation, the update agent 204 of Target1 202 checks its update list 224 at the onsite or offsite update server 220 to see if a new package should be installed. If one is there, the update agent 204 checks to see if the package is already in memory on the update server 220. If so, the update agent 204 attempts to install the software patch directly from the update server 220. If not, the update agent 204 attempts to install the software patch directly from the package computer location 232. In some instances, this is successful, in which case the update list 224 is updated.

In other cases, a download 218 will be obstructed by the firewall 214. If this happens, the update agent 210 informs the update server 220 and then the update server 220 itself will attempt to retrieve the package and place it in memory 228. From that memory on the update server, the software is installed directly to the target machine.

A monitor checks to see that the software installs properly on the target 202, 208, and then continues checking (or can be notified) to ensure that the updated software runs correctly and that the target computer itself doesn't experience any problems in what appear to be unrelated areas. Should the package fail to install properly, or create problems for the software program that was patched, or create other problems on the target computer, the package can be automatically removed and the computer restored to its preinstalled state or another acceptable state in which the update has been removed or disabled, and the target computer is in a workable state. If the package has been installed on more than one computer, they all can be removed. If the error occurs in the middle of a rollout to many computers, the rollout can be halted and the software removed or disabled. The monitor may be located on the update server 220, on a repository site 600, at least partially in the update agent 204, 210, and/or in a combination of such locations.

When there is a problem with an installation, or when an installation is successful, an administrator can be notified by email, by pager, or by some other notification means.

The update agent 204, 210 can also be used to survey its own target computer, and this information can be stored in a database offsite or at another location. This information can then be used to determine what updates a given target computer needs in order to have the most appropriate configuration. When a new software patch becomes available, the stored information can be used to determine if a particular target computer needs the patch.

It should be noted that target computer can include any type of server or workstation, regardless of operating system or installed software. Moreover, the scope of the invention applies to many other devices including wireless devices (mobile phone, personal digital assistant, pocket computer, etc.), intelligent switch devices, hubs, routers, and any other type of Internet-attachable device.

Other aspects and advantages of the present invention will become more fully apparent through the following description.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and thus do not limit the invention's scope. In the drawings:

FIG. 1 is a diagram illustrating one of the many distributed computing systems suitable for use according to the present invention.

FIG. 2 is a diagram illustrating systems according to the present invention.

FIG. 3 is a diagram illustrating methods according to the present invention.

FIG. 4 is a diagram further illustrating methods according to the present invention.

FIG. 5 is a diagram further illustrating systems according to the present invention.

FIG. 6 is a diagram further illustrating systems according to the present invention.

FIG. 7 is a diagram further illustrating systems according to the present invention.

FIG. 8 is a diagram further illustrating methods according to the present invention.

FIG. 9 is a diagram further illustrating systems according to the present invention.

### DETAILED DESCRIPTION OF THE PREFERRED EMBODIMENTS

The present invention provides systems, methods, articles, and signals which help update existing software across a remote network. The invention relates more specifically to updating software across a client-server system with little or no need for human oversight, and without requiring copies of the software patches on an administrative machine on the network whose clients are being updated. The update is automatic, and it can detect errors within a specific update and automatically rollback a faulty update to leave the network in a usable state.

Separate figures discussed herein illustrate various embodiments of the present invention, but the discussion of a given figure is not necessarily limited to a particular type of embodiment. For example, those of skill will appreciate that the inventive methods may also be used in configured storage media and/or computer system implementations according to the invention. To prevent unnecessary repetition, the discussion of methods thus applies to articles and systems, and vice versa, unless indicated otherwise. It will also be appreciated that method steps or system components may be renamed, regrouped, repeated, or omitted, and that method steps may be ordered differently and/or performed in overlapping execution, unless the claims as properly understood call for particular steps or components and/or require a particular order of execution.

For the reader's convenience, some pertinent information on related technologies such as networks and firewalls is provided below. The invention goes beyond previously known technologies, but it may partially comprise or rely on earlier advances in computing and networking and/or be used together with such earlier advances.

Systems Generally

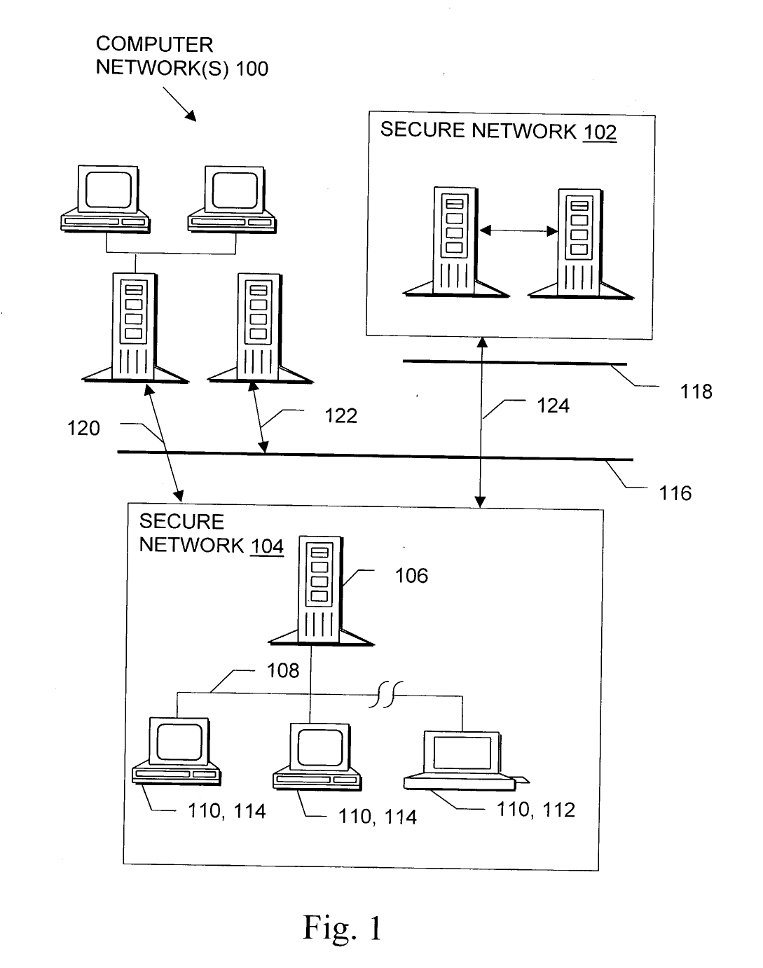

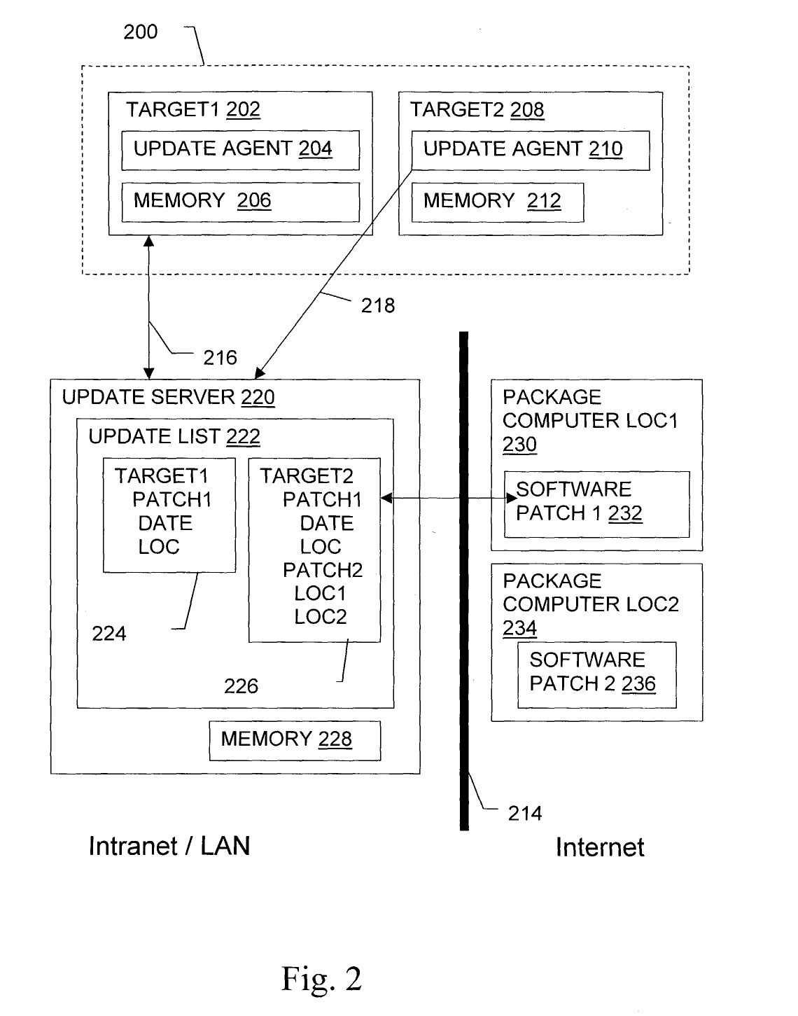

As shown in FIG. 1, computer networks 100 such as secure computer networks 102, 104, may be configured according to the invention. Suitable computer networks 100, 102, 104 include, by way of example, local networks, wide area networks, and/or portions of the internet. “Internet” as used herein includes variations such as a private internet, a secure internet, a value-added network, a virtual private network, or an intranet. Secure networks may be secured with a security perimeter which is defined by firewall software 116, 118 routing limitations, encryption, virtual private networking, and/or other means. The network 100, 102, 104 may also include or consist of a secure intranet, which is a secure network such as a local area network that employs TCP/IP and/or HTTP protocols internally. The computers 10 connected by the network for operation according to the invention may be workstations 14, laptop computers 12, disconnectable mobile computers (such as PDAs or other wireless devices), servers, computing clusters, mainframes, or a combination thereof. The computer hardware may be general-purpose, special purpose, stand-alone, and/or embedded. The network 100 may include other networks, such as one or more LANs, wide-area networks, wireless networks (including infrared networks), internet servers and clients, intranet servers and clients, or a combination thereof, which may be protected by their own firewalls.

A given network 100 may include Novell Netware® network operating system software (NETWARE is a registered trademark of Novell, Inc.), NetWare Connect Services, VINES, Windows NT, Windows 95, Windows 98, Windows 2000, Windows ME, Windows XP, Windows 2K3, LAN Manager, or LANtastic network operating system software, UNIX, TCP/IP, AppleTalk and NFS-based systems, Distributed Computing Environment software, and/or SAA software, for instance (VINES is a trademark of Banyan Systems; NT, WINDOWS 95, WINDOWS 98, WINDOWS 2000, WINDOWS ME, WINDOWS XP and LAN MANAGER are trademarks of Microsoft Corporation; LANTASTIC is a trademark of Artisoft; SAA is a mark of IBM). The network may include a local area network which is connectable to other networks through a gateway or similar mechanism.

One system according to the invention includes one or more servers 106 that are connected by network signal lines 108 to one or more network clients 110. The servers and network clients may be configured by those of skill in the art in a wide variety of ways to operate according to the present invention. The servers may be configured as internet servers, as intranet servers, as directory service providers or name servers, as software component servers, as file servers, or as a combination of these and other functions. The servers may be uniprocessor or multiprocessor machines. The servers 106 and clients 110 each include an addressable storage medium such as random access memory and/or a non-volatile storage medium such as a magnetic or optical disk. The signal lines 108 may include twisted pair, coaxial, or optical fiber cables, telephone lines, satellites, microwave relays, modulated AC power lines, and other data transmission “wires” known to those of skill in the art, including wireless connections. Signals according to the invention may be embodied in such “wires” and/or in the addressable storage media.

In addition to the network client computers, a printer, an array of disks and other peripherals may be attached to a particular system. A given computer may function both as a client 110 and a server 106; this may occur, for instance, on computers running Microsoft Windows NT software. Although particular individual and network computer systems and components are mentioned, those of skill in the art will appreciate that the present invention also works with a variety of other networks and computers.

Suitable software and/or hardware implementations of the invention are readily provided by those of skill in the art using the teachings presented here and programming languages and tools such as Java, Pascal, C++, C, Perl, shell scripts, assembly, firmware, microcode, logic arrays, PALs, ASICs, PROMS, and/or other languages, circuits, or tools.

Configured Media Generally

The servers 106 and the network clients 110 and individual computers 110, 114 are capable of using floppy drives, tape drives, optical drives or other means to read a storage medium. A suitable storage medium includes a magnetic, optical, or other computer-readable storage device. Suitable storage devices include floppy disks, hard disks, tape, CD-ROMs, PROMs, RAM and other computer system storage devices. The substrate configuration represents data and instructions which cause the computer system to operate in a specific and predefined manner as described herein. Thus, the medium tangibly embodies a program, functions, and/or instructions that are executable by the servers and/or network client computers and/or individual computers to perform updating, monitoring, administrative and/or other steps of the present invention substantially as described herein.

Firewalls

Network administrators generally do not allow just any information into their system. Rather, they use a firewall 116, 118 to protect the network. A firewall is hardware and/or software device that screens incoming messages (often based on content, origin, or nature of request) and only allows to pass those that are deemed safe. Three main types of firewalls are screening routers (also called packet filters), proxy server circuit-level gateways, and proxy server application-level gateways. Screening routers can base decisions on external information about a network packet such as its domain name and IP address, so messages that come from acceptable domain names and IP addresses can be allowed through 120, 124 while refusing messages from other locations 122. Proxy server circuit-level gateways disguise information about an internal system when passing the information to an external system. The IP addresses of the internal computers are typically replaced with the IP address of the proxy. At this level, authentication can be required. Proxy server application-level gateways provide all of the features of screening routers and circuit level gateways while also allowing the contents of the packets themselves to be evaluated. Messages can be rejected for content as well as for security violations.

Software Installation

System administrators often need to change the software on a specific machine. A new piece of software must be installed for the first time, as when a new application is added to a machine. An already-installed piece of software can be updated, as when a new version of an existing piece of software will be installed on a specific machine; this is also referred to as “replacing” the software. A data file of an existing piece of software can be updated without otherwise changing the software configuration, as when tax tables are updated on an accounting program, or when anti-virus software files are updated. If a problem is discovered in an existing piece of software, then a fix or patch can be installed. Any or all of these changes to the state of a specific machine or machines are referred to in this patent as “installation”. Similarly, the words “package,” “patch,” and “update” should be given the broadest possible meaning. For example, package could refer to an entire program including all the necessary files, to one or more data files, to a software patch to an existing file, to a change to a configuration file, to a *.dll file, a driver file for a specific piece of hardware attached to a computer and/or a computer network, and so on. “Update” refers to at least attempting to install a package on a computer.

Methods Generally

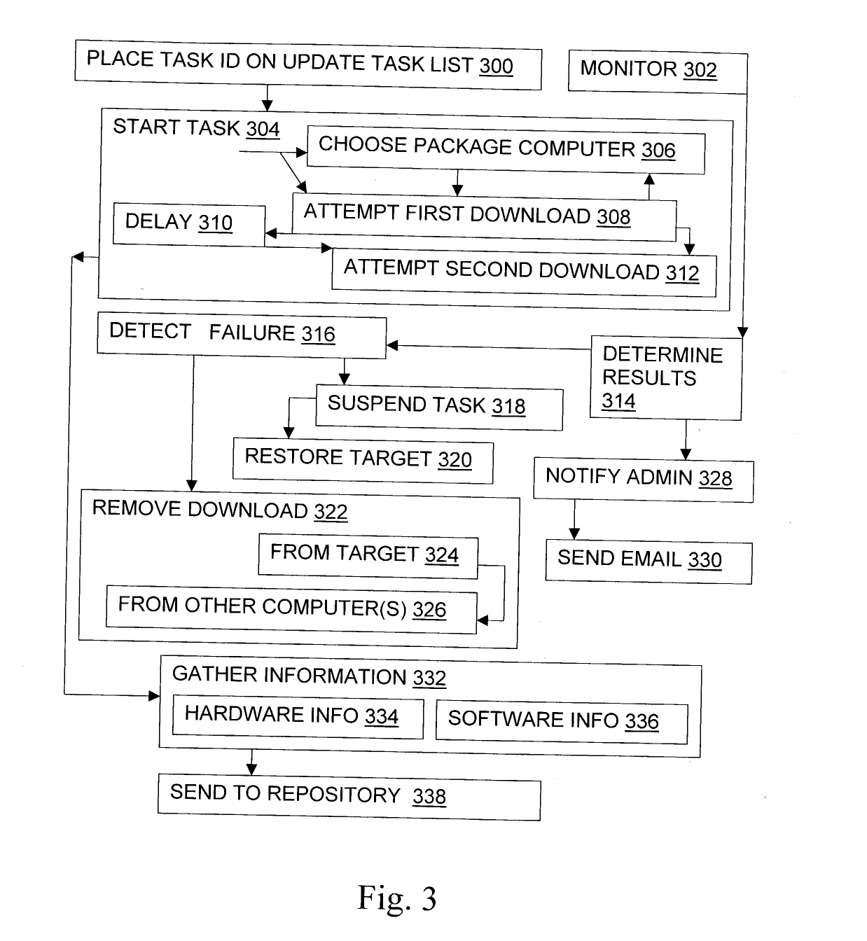

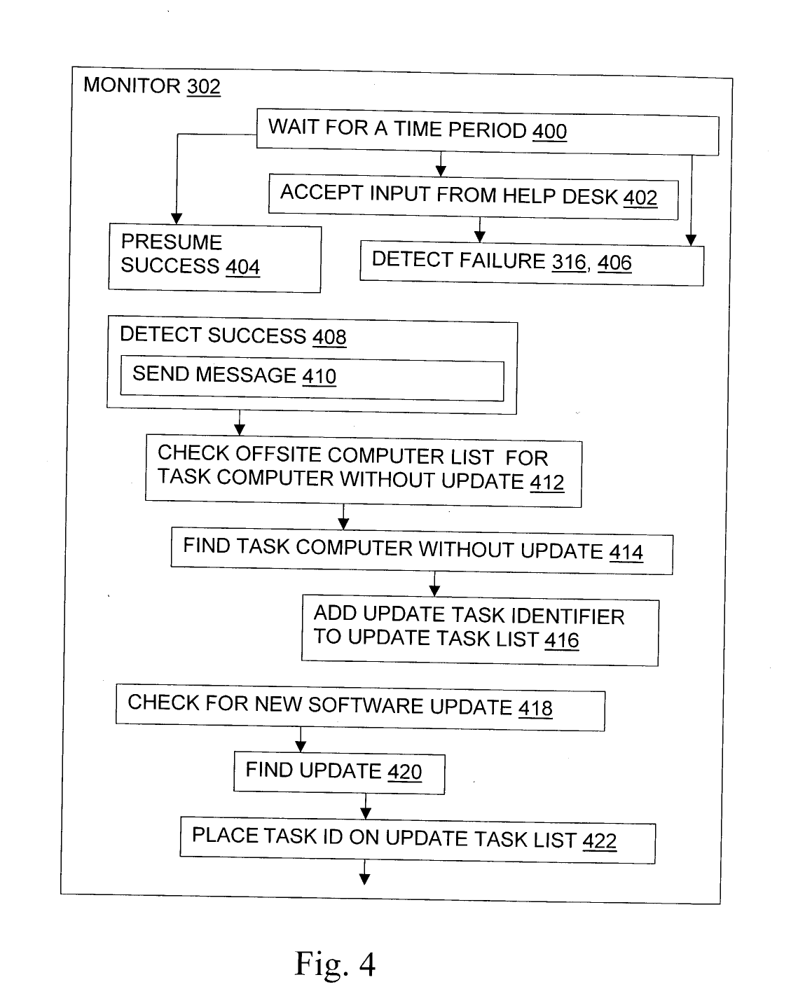

With reference to FIGS. 3, 4, and 5, one embodiment of a method operating according to the present invention includes a target computer 500 in a pre-update state. The target computer 500 is the computer that the invention will at least attempt to update; not every embodiment of the invention requires that the update be successful. An update server 528 is connected across a network 524 to the target computer. In some implementations the target computer has a network connection, such as a connection through a winsock layer. Typically, the target computer is protected by a firewall 526, as explained above, but the update server can drill through the firewall to access the target computer.

Many existing enterprise software management tools use agents. Examples include Microsoft SMS software, Microsoft Active Directory software, IBM Tivoli products, Symantec anti-virus software, McAfee anti-virus software, and Novell ZENworks software (marks of their respective owners). In large networks, agents can wake up and report in parallel to a server when they have information to report. By contrast, tools that lack agents rely on remote API calls, which are polled continuously by the server, making them linearly scaleable in performance rather than parallel processing as seen in the preferred embodiment.

Agents in embodiments of the present invention can receive compressed files to conserve network bandwidth. Compression also enhances security, because decompression errors may indicate that a patch has been tampered with.

An inventive agent can also resume a download when a mobile target bearing the agent is disconnected and then reconnected to the network at another location, unlike patch management tools that lack agents and therefore download entire service packs or files after being interrupted. Tools lacking agents may also generate uncontrolled spikes in bandwidth utilization as patches are deployed, whereas some embodiments of the present invention permit an update server to be controlled by an administrator so that the server uses only a specified amount of bandwidth per agent connection (bandwidth throttling).

Conventional patch tools that rely on a permanent LAN/domain connection and lack client agents may rely on a remote registry service, which provides registry information to a remote computer. The remote registry service is not available on the Windows 95, Windows 98, or Windows ME platforms. Such a service can be a security risk in organizations whose client computers are on the Internet, because they allow remote computers to read the registry of a client, thereby providing information that can be used to guide infiltration or other attacks on the client's security. Embodiments of the present invention preferably avoid using a remote registry service, due to the security risk.

An update agent 508 is located at each computer that is to be updated. The update agent is a software component (usually not very large) that may be installed initially, either in the traditional manner or by using the invention, on the network target machines such as workstation(s) and/or server(s). The update agent is capable of operating in the place of the human administrator, at the direction of the human administrator, to perform work in a manner similar to what could be performed if the human administrator was actually present at the machine. The update agent knows how to perform four basic tasks: 1) how to contact the update server 528 to retrieve a list of tasks, 2) how to start the tasks in the task list received, 3) how to process policy information for hours of operation and so forth, and 4) how to register with the Update Server.

The update agent is capable of updating, configuring, or replacing itself without the need for manual intervention after the initial install. Typically a small boot-strap agent will be installed initially, but will grow in abilities as the administrator dictates or as required to fulfill administrator requests. The update agents of different sorts of target computers 500, such as onsite administrator computers, server computers, and client machines, can all start out as the same version of a single agent. Machines in a given network can all have a the same agent installed, or machines can have unique agents installed. When there is more than one client, each can have a different update agent initially, or a mix of agents can be installed on different client machines, as is chosen by the administrator, or as is set up as a default. Similarly, multiple servers and administrators can also have a mix of different agents initially installed. As the agents for the individual target computers change, they can all change in concert or they can diverge. In some embodiments, the agents may all start out different and then converge in functionality.

The offsite location of the update server 528 is a location distinct from the target computer. The location may be offsite at a completely different vendor, or offsite at a different physical location from the target computer 500 but at a location managed by the same entity, at the same physical location. It may be at a different-appearing location from the target computer 500, such as at a subcontractor location, or at some other distinct-appearing location. The important point is that as far as an individual target computer operating system is concerned, the work appears to be off-site. One embodiment locates the update server on the target computer 500 but in a fashion (such as in a different partition) that appears offsite.

The actual update material that is to be installed on the target computer is often stored at a separate location (known as the package computer) apart from the update server and the target computer. The software update itself can be any of a wide variety of software that can be updated across a network, such as an incremental software patch, a new software program never before installed on the target computer, an update to an old program, software scripts, data files, or even an update of the update agent.

If a known condition is met, during a placing step 300, a task id is placed on an update task list 222. The known condition could be that the patch is not currently on the computer, that the administrator has given assent, the owner of the target computer 500 has permission from the owner of the package, the fact that no one has specifically denied placing privileges, or some other known or inventive condition. The update task list located on the update server is associated with a specific target computer 500, and specifies at least one download address where the software update can be found. The download address can be in any format that is understandable to the computers. The invention does not depend upon any specific addressing convention. Two common addressing formats in use currently are the “Universal Resource Locator” and “fully qualified domain name” formats. Other formats are PURLs (Persistent Uniform Resource Locators) and URN's (Uniform Resource Names), and other naming schemes may be known in the future. Other information that may be included in the task identifier, such as a date the download will first be attempted. Multiple download addresses, each of which specifies a location where the software update can be found, may all be associated with a specific software update.

During a starting task step 304, the software update is at least attempted to be uploaded from the package computer 567 to the update server 528. During an optional choose package computer step 306, if more than one download location is placed on task id list 226, the location that the software update will be downloaded from is chosen. The choice can be made by any known or inventive method, such as using the first location on the list, using the location that a test message returns from most rapidly, using the first available machine, and so on.

Once a location for the update is known, the software download is attempted from the location of the package computer 548 to the memory 530 of the update server 528. If the download is unsuccessful, then in one inventive method another location from the list of possible locations in the task update list is chosen, and the download of the software update is retried. In some implementations, if the download can't be completed for some reason, the update server 528 waits for a time and tries to download from the package computer 567 again. If the download is successful, then the update server 528 attempts to download 312 the software update to the target computer 500.

Once the download is in cache or other memory in the update computer a second download 312 is attempted to download the software package from the update server to the target computer. In some embodiments of the method, the second download 312 is delayed 310 by some predetermined criterion. This delay may be from the start of the first download, with the delay period based on an estimate of the time needed to download the software update from the package computer to the update server. The second download may also be delayed to a specific time of day when the target computer 500 has less of a chance of being used, such as after a business closes for the day. Other known or inventive delay criteria may also be used.

A monitor 302 checks the installation, performing the role typically played by an administrator, to determine the results of the installation 314. Once the results are known, an administrator can be notified 328. Notification can be by sending an email 330, by paging someone, by sending a pre-recorded phone message, or by any other known or inventive method and means.

If the monitoring step detects a failure 316, then the task that failed is suspended 318. The first download 308 to the update server 528 could fail, as could the second download from the update server 528 to the target computer 500. If there are multiple target computers having the software update installed, the Nth installation could fail, and so on. Determining results preferably goes beyond simply ensuring that the software update appears to have installed properly, and in some embodiments of the invention extends for a time beyond the installation. For example, one embodiment of the monitor will test a patch application by having it installed on only one target computer, assuring that it downloads properly, installs it and then watching it for some period of time until the administrator who sets the time delay gains enough confidence in the patch to allow it to be applied to other target computers. Should the application of this patch cause abnormal activity, as noticed by undesirable behaviors either in the program whose software was modified or elsewhere in the computer, the rollout can be automatically suspended until the problem is resolved.

Furthermore, in some instances when failure is detected the software update is disabled or removed 324 from the target computer, and that machine is returned substantially to its pre-update state or another acceptable (working) non-update state. This may mean that the installed software is taken off the target machine 322; or that not only is the software removed, but all the ancillary files (.dll's, .exe's, etc.) are restored to their pre-update state. In other instances it may mean that the target computer or some portion thereof was backed up before the software update was installed, and the backup itself is restored onto the machine.

If there are multiple target computers 500, failure may be detected by the monitor after the software has been installed on one or more machines. In this case, the software update can be removed 322 from not only the target computer 500 where the failure was spotted, but it can also be removed 326 from all of the other target computers 500 where the software was previously installed 326. The removal request can come from an administrator or removal can be performed automatically after failure is detected 316.

The monitor 302 may perform more tasks than simply waiting to hear if a software package has installed successfully. For example, in some instances the monitor waits for a time period 400 after the installation and if it has not heard otherwise, assumes that the installation was successful.

Administrators and administrator helpers can benefit greatly from a central repository where they can enter and retrieve information regarding requests for help. One such method is help desk “ticketing”. Ticketing records the requester, the type of request, when help was requested, when the response to the request was completed, and other useful information. A PatchLink HelpDesk service provides facilities for administrators to manage their network requests and network resources, both people and computer resources, via one central repository. PatchLink HelpDesk software provides these facilities across the internet without an invasive application install on the administrator's network that introduces yet another resource that has to be managed, backed up, and updated—this is taken care of transparently at an offsite Management Center.

A website, reachable by a standard web browser or some other known or inventive network connection, provides the facilities to use the help desk services. A preferred implementation is currently at the PatchLink web site, reachable at www.patchlink.com. Simple web forms support the data collection required to begin the enrollment process. Once the enrollment process is complete, the administrator can license one or more services on a recurring subscription basis.

The enrollment process is begun when the administrator initiates the process by signing up and indicating a desired level of participation. A preferred embodiment of the invention has three different user levels: guest, regular, and executive. A guest is allowed to view the web site and can read the user forums but cannot post to the forums. A regular member can perform guest functions and can also chat in chat rooms, and post to forums. An executive member has a subscription to the site. He or she can perform regular member functions, and can also use the more advanced features of the site, such as offsite automatic package updates (e.g., PatchLink Update services), offsite monitoring (e.g., PatchLink Monitor services), and the offsite help desk functions (e.g., PatchLink HelpDesk services).

One embodiment of the method entails an email being sent to a customer care agent assigned to the customer's telephone area code. The customer care agent telephones the pending user to complete the enrollment process. The customer care agent collects the necessary identity information and payment information, and then upgrades the pending user's account to permit use of the account, making the pending user an administrator/user. The areas the administrator/user can participate in or use is controlled by entries in the licensed product's table of the update host's database. These entries are created by the customer care agent during the enrollment process.

Recall that all these services are available to the administrator via a browser or other network connection across the internet. When a monitor enters a ticket into the help desk and initiates a rollout in some instantiations of the inventive method, the monitor then decides whether a failure has occurred 316, 406. To decide the monitor may look at what software updates have recently been installed, how long ago the installations occurred, the current hardware and software configuration, and so on. Which incidents are considered failure can be, without limitation, set by an administrator; defaults can be used, and judgment of the help desk personnel can be taken into account.

In a detect success step 408 the target computer 500 sends a message 410 to the update server after the download from the update server to the target computer has completed successfully. The monitor can presume success 404 if a specified time period has passed without noticing or being notified of a failure.

Failure can be detected in other ways 316, 406. For instance the target computer can notify the monitor that a failure has occurred; a user can notify the monitor through the help desk or through a direct link that a failure has occurred; when a target computer does not contact the monitor within a specified time from the beginning of the second download 312 onto the target machine, a human administrator can declare that a failure has occurred; and so on. Notice that even after the monitor has declared the outcome of a download to be a success, later events, such as an indication of failure from the help desk, can cause the monitor to declare the download to be a failure.

In one embodiment of the invention, the update server 528 waits for a confirmation of a successful installation (by the monitor, or by another known or inventive contact method) before the next target computer 500 has the software update placed on its update list 222. The update server checks for a target computer 500 that is eligible for the software update but has not yet received it 412. If one is found 414 the appropriate task identifier, specifying the target machine, the software update, and the location, are added 416 to the update server's 528 task update list. This way, rather than a mass update where all eligible computers have the software installed on them en masse, the rollout proceeds one computer at a time until, after a default or user-defined number of successful installations, the rollout is deemed a success; at that juncture the software update is made available to more than one target computer at a time.

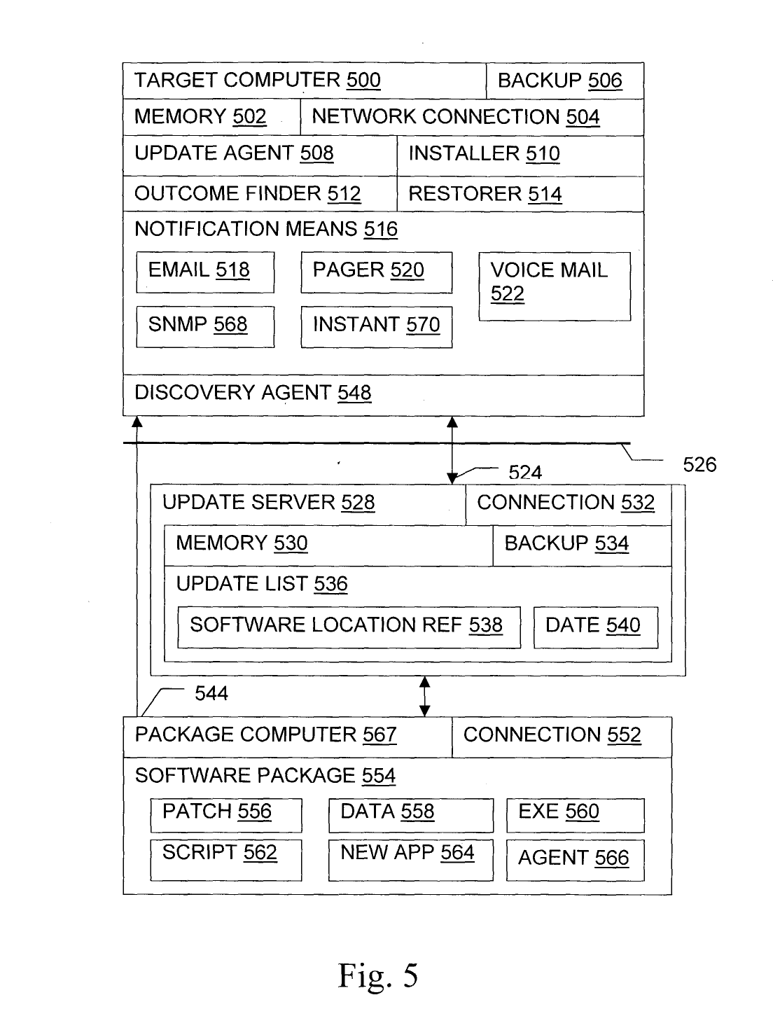

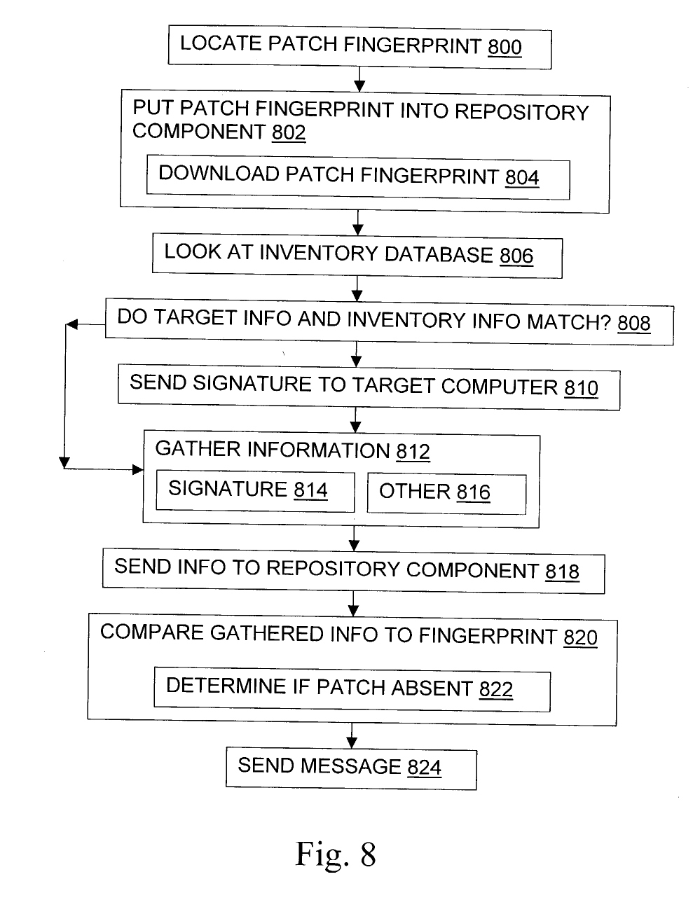

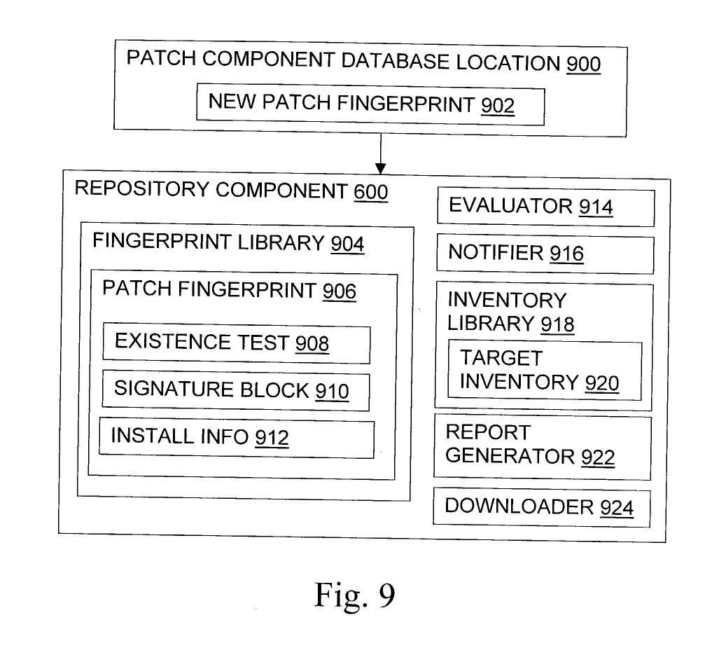

It is not always clear by looking at a specific target computer 500 what software packages and patches have been installed. The invention includes a method to analyze a target computer 500 to ensure that a given patch has not already been installed on the computer 500 before the invention attempts to install that patch. The following discussion includes references to FIGS. 8 and 9 and continuing reference to FIG. 5.

A patch fingerprint which defines a specific software update is described in greater detail below. The patch fingerprint is located 800 by monitoring a patch component database location 900 for a new patch fingerprint 902. The word “new” here indicates that the patch has not yet been downloaded into the repository component 600, or for some reason needs to be downloaded into the repository component again, even though it has been downloaded previously. There may be one or many patch component locations; those locations may be on a separate computer connected to the system through a network link, on the update server 528, on the target computer 599, on the package computer 567, on a non-networked location such as a CD, a tape, a floppy disk, etc., or some other known or inventive location.

Once the patch fingerprint 906 is located 800, it is placed 802 into the repository component 600. The usual method of placement is to download 804 the patch fingerprint 906 into the repository component, but in some embodiments the fingerprint 906 will be on the same file system, so the patch fingerprint will be copied without using the network, such as copying between partitions.

The illustrated patch fingerprint comprises one or more general inventory install dependencies 912 that can be used to take a high-level look to see if a specific patch can be installed on a machine. It also includes a signature block 910 that can be used to request specific information from a target computer 500, and an existence test 908 which can use the signature block information to determine if a specific patch has been loaded on a machine.

In some versions of the invention, the inventory install dependencies 912 describe at least some of the necessary software and hardware that must be installed on the target computer 500. These dependencies 912 are compared 808 with information about the target computer 806 previously stored in the inventory library 918. If the install information and the inventory information don't match, then the patch is not installed. In some versions of the invention a message is sent to at least one administrator containing a list of components required (such as necessary hardware and software) for the install.

If the necessary inventory information is on the target computer 500, or if the inventory info is not used, then the signature block is sent 810 from the repository computer 600 to target computer 500. The information requested in the signature block 814, which may consist of more specific install information, is gathered 812 by the discovery agent 548 and then sent back to the repository component 818. In some versions of the invention, the discovery agent also gathers other information 816 about the target computer such as usage statistics, hardware and software installed, configurations, etc. This information can then be used to populate the inventory library 918.

Once the signature information 910 has been sent to the repository component 600, an evaluator 914 evaluates at least a portion of the specific install information requested by the signature block using the existence test 908, and in some instances the inventory install information 912, to determine if the patch is absent 822 on the target computer 500.

As an optional step, once it has been determined if the patch is absent a message is sent 824 to at least one address associated with an administrator. This message may be sent using a variety of methods, including email, pager, fax, voicemail, instant messaging, SNMP notification, and so on.

Patch Fingerprint

With continuing reference to FIGS. 5, 8 and 9, one embodiment of the system verifies that a software package can be or should be installed on a given target computer 500 before attempting installation. To do so, a patch fingerprint 906 is used, e.g., by an agent on a client. The patch fingerprint defines how to determine if a given software package/incremental patch has been previously installed. It may also define a minimum hardware/software configuration necessary for the patch installation. These patch fingerprints 906 are stored in a fingerprint library 904. The fingerprint library 904 is located on a repository component 600. This repository component 600 may be located on the update server 528, or may be in a separate location accessible to the update server 528 and the target computer 500. Some versions of the invention also include an inventory library 918 which contain target inventories. Each target inventory 920 contains the hardware and software information about a defined set of target computers 500. This defined set may include as few as one computer or as many as all of the computers in a given network, or some number in between.

The fingerprint library 904 can be automatically replenished. In some embodiments, at least one, but possibly several, patch component database locations 900 are monitored 800 for new patches 902. In some embodiments of the invention a signal from the locations 900 indicates to the repository component 600 that new patches 902 are available 800. In the preferred implementation the fingerprint library 904 is updated with new patch fingerprints at specific time intervals. After the repository component 600 is aware of the new patch fingerprint, the patch fingerprint is placed into the repository component 802, usually by using a downloader 924 to download the new patch fingerprint. Patch fingerprints may be entered into the repository components in other ways, however. For example, one or more patch fingerprints may be manually installed into the fingerprint library by an administrator.

Inventory Library

The repository component 600 also contains an inventory library 918. A discovery agent 548, which in some embodiments initially resides on the update server 528, is installed from the update server 528 to the target computer 500 using known or inventive methods. This discovery agent 548, described in greater detail below, inventories at least some of target computer 500's software information 606, hardware information 608 including specific software updates and patches installed, usage information 604, registry information 612, web information 610, configuration information 614, services 618, file information, patch signatures which have been utilized, etc.

This information, or a subset or superset thereof, is then sent, in some embodiments in compressed form, to the target computer inventory 920 in the inventory library 918. Result information can be quite voluminous, and hence may be compressed for efficient upload and to minimize bandwidth usage on the customers network. A preferred implementation sends the data using an XML data transfer, though any other known or inventive data transfer method can be used. Transfer of inventory information may also be encrypted within a customer network to prevent unwanted wire-level snooping of system configuration information.

Report Generator

With this information, a report generator 922 can present a user with detailed reports of the current patch status for all computers within the network, illustrating the number of computers needing the patch, the computers already installed with the patch, computers that can't receive the patch until hardware or software is upgraded and so on. In addition, the report generator 922 can provide a partial or complete inventory of the computers attached to the network. In some embodiments the report generator 922 provides graphical presentations of the inventory for analysis by the administrator, both to track location of hardware as well as to ensure software license compliance. However the repository component 600 also uses the inventory library 918 information as well as detected fingerprint information to distribute relevant signatures 910 from the patch fingerprint 906 to the discovery agent 548, thus greatly optimizing the patch discovery process by eliminating unnecessary scanning work at the target computer 500.

Discovery Agent

One optional step to decide if a given software program or patch can be installed is by verifying that the necessary hardware, if applicable, is present, and/or the necessary software is present. For example, some programs may require a specific operating system, some programs may require a certain processor. As an example, if an update of Microsoft Word software is to be installed, it is necessary that Microsoft Word software be on the machine. These high-level dependencies are stored, in some versions, in the inventory install block 912 in the patch fingerprint. The information in the inventory install block is generally high level enough that it can be pulled out of the target inventory 920 of the specific target computer 500 stored in the inventory library 918.

In some implementations of the invention the patch fingerprint 906 also includes installation dependency information 912. This, as explained above, is information about the target computer 500 that can be expected to be found in the inventory library, and so can be checked without querying the target computer 500. This includes software that should be present (such as a specific version of a program, a patch, a data file or a driver) a hardware component that should be present, or specific hardware and/or software that shouldn't be present.

If the inventory library does not have an up-to-date inventory for the target computer 500, the discovery agent can be used to scan the target computer 500 for inventory information; it does not necessarily need to also scan simultaneously for signature information. In the preferred implementation, the first time that the discovery agent 548 runs on a given target computer it scans only for inventory information and then loads that information into the inventory library 918; it ignores the patch fingerprint information. At other times when the discovery agent 548 runs it may ignore inventory information and may, rather, be used to look up specific signature information 910 to test for the existence of a specific patch. When the signature block information is looked for, values such as registry entries and INI file values may be inspected for existence, or the actual value may be returned to the repository component 600.

Each Patch fingerprint comprises a signature block 910 and an existence test 908. The patch signature block is a set of information requests, the information itself to be gleaned from a target computer 500 which will then be used to determine if all necessary bug fix and security patches are installed. Examples of patch signature block information include but are not limited to file, hardware, registry and configuration information, a specific file name or directory name, all or part of a path that a file is expected to be found in, a specific version number of a file, a created date of a file, a specific file version of a file, and a specific registry value.

In one implementation the fingerprint library 904 is a SQL database. The patch signatures 910 are extracted from the SQL fingerprint library and then sent to all target computers that meet the dependency criteria for operating system and installed software as specified in the inventory install information 912.

A preferred implementation employs an XML-based request input file. The result file sent back to the update server 528 also employs XML formatting. This result file contains the signature information for the target computer, and may also contain the software and hardware inventory updates. The inventory and signature information sent to the update server can be quite voluminous, and so are compressed and may also be encrypted in the preferred implementation. The following is a sample patch signature that will gather registry information for Microsoft Outlook as well as the EXEs date and time, and information in the registry:

<file componentid=“1” reportID=“1”>

<name>outlook.exe</name>
<path> </path>
<version>9.0.2416</version>
<created> </created>
<size> </size>
<root>HKEY_LOCAL_MACHINE</root>
<Key>SOFTWARE\Microsoft\Windows\CurrentVersion\App

Paths\OUTLOOK.EXE</key>

<value>Path</value>

</file>

Once the discovery agent on the target computer has returned its scan results for the signature, the existence test 908 logic is used by the evaluator 914 to infer whether that particular computer actually has the patch or not. This algorithm minimizes the number of tests that must be done by the evaluator: its sole responsibility is to discover information—allowing the data analysis to be done by the repository component 600 itself. Distributing the workload in this fashion provides a better implementation for scanning and analyzing huge numbers of workstations and servers.

Each existence test is specific to a given patch. A sample existence test might appear as: if registry QQ contains value ZFILEVAL or (if file Z123.bat was changed on date Dec. 12, 2000 at 11:52 pm and file Z is of size ZFILESIZE) then the patch ZPATCH is present. The preferred embodiment of the patch fingerprint library is an SQL database, but other known or inventive databases can be used.

Note that a patch fingerprint may also contain dependencies to other Finger Print definitions: for example, “MS-023 IIS Vulnerability Fix” patch might hypothetically require the presence of “Microsoft Windows Service Pack 2”. This is used to further optimize where the patch signatures are actually sent. These may sometimes be used in the install dependencies info 912 and other times in the signature block 910, depending on circumstances.

In addition, fingerprint definitions 906 are also normally associated with a software package 554 suitable for deployment by the system. Once the need for a particular patch has been established by scanning its signature(s) on a computer or all computers within the network, it can then be quickly deployed by the administrator by merely selecting the date and time.

A fingerprint definition 906 may also contain a logical expression that should be evaluated to assess whether the other elements within the patch signature should be evaluated to TRUE (patched) or FALSE (not patched). The expression is a simple logical statement such as (A AND B)|C where A, B, and C refer to other fingerprint definitions within the patch signature.

In some implementations the downloader 924 regularly checks the patch component database for new patch fingerprints. When a new patch fingerprint is located, it is downloaded into the repository component. The evaluator compares the dependencies needed for the specific patch implementation listed in the install info 912 with each of the target computer 500 specifications listed in the inventory library. Then an update list is created which may identify all of the target computers 500 that need the patch, all of the target computers that don't possess the patch, all of the target computers that can receive the patch, as they have the necessary dependencies, and/or all of the target computers 500 that have already received the patch. This update list may now be used to update the target computers, and/or may be sent to an administrator by a notifier 916.

In some instances of the invention the patch component database is owned by someone other than the target computer 500 owner. Only if this patch update host has given permission to the target computer 500 owner will the downloader be allowed to download the new patch fingerprints into the repository component. The permission may comprise a purchase agreement, a lease agreement, subscription for download permission and an evaluation agreement.

If any modifications are made that may be of interest to the administrator, the notifier 916 will send a notification message containing the new patch updates that have become available or the patch-related state changes that have occurred in his network configuration. Notifications can be sent via e-mail, pager, telephony, SNMP broadcast or Instant Message.

Target Computer

In one embodiment, the inventive system comprises three pieces: a target computer 500, an update server 528, and a package computer 548. The target computer 500 has a memory 502, and a network connection 504, which in at least one implementation of the invention is a winsock layer. A socketless protocol can be implemented, or any other known or inventive network connection can be used. The update server 528 has a memory 530 that may include an optional backup storage 534, and a network connection 532. The package computer 567 has a memory 550, and a network connection 552. FIG. 5 shows one target computer 500 for convenience but there may be many more in a given embodiment. Likewise, one update server 528, and one package computer 567 is shown for convenience, the invention may only require one but also support two or more. In a preferred embodiment these pieces are all separate computers, but they can be virtual pieces of the same computer, such that they appear to be distinct. For example, the “package computer” piece may reside on a different partition of the update server or the same partition.

The target computer contains a network connection 544, which may be protected from the outside by a firewall 526 as is discussed above. Different target computers within a network may run on different platforms; for instance, some may be Windows machines, some Unix machines, etc. The same update server 528 can be used for all the platforms, or different update servers 528 can be specified by platform type, or the update servers 528 can be assigned to target computers 500 using a different schema.

The target computer 500 also contains an update agent 508. The update agent is a software component that can be installed using the inventive method on multiple machines at a time or, in some embodiments of the system, can be installed in the traditional manner on the target computer 500. Once registered, the update agent 508 knows how to perform three basic tasks: 1) how to contact an update server 528 to retrieve its list of tasks from its update list 536, 2) how to start the tasks in the task list received, and 3) how to retrieve policy information received from the update server 528 that control polling interval, hours of operation, and so forth.

Update Agent

The update agent of target computer 500 contacts the update server 528 to determine if there is work for the agent 508 to do. The update server 528 determines this by analyzing an agent's update list queue 536. This update list 536 contains, at a minimum, a software location reference 538, but can also contain a date 540 that indicates the earliest date that the software package 554 can be installed, and multiple software location references, if the same software package is available from multiple locations. The types of software 554 that can be updated comprise, without restriction, patch files 556 that update a currently installed software application on the target computer, data files 558, script files 562, new application files 564, executable files, 560 driver updates, new software versions and updates to the update agent file itself 566.

When the update agent discovers an entry on its associated update list 536, with an appropriate date 540, if any, the installer 510 initially checks to see if a copy of the software package already exists in memory 530 on the update server 528. If found, it then downloads the software package directly from the update server. This situation may arise when a previous target computer 500 has requested the software package 554 from the update server 528.

If the software package is not found, the installer 510 then attempts to download the update directly from the package computer location given in the software location reference 538 to the target computer memory 502 using its network connection. This will be possible if there is no firewall 526, or if the update server can connect to the package computer location 548.

When an administrator builds a package that instructs the update agent 508 to retrieve the files from a “non trusted” source such as the package computer 567, the installer 510 will be unable to retrieve the resource directly. However, the update agent can ask the update server 528 to retrieve the package. In some implementations there are multiple update servers and the update agent 508 decides which one of them to access using some predetermined criterion. Examples include selecting the first update server 528 that is available, selecting the least-busy update server, selecting the update server that is “closest” in networking terms, and so on.

In one implementation of the invention, if the update server 528 can reach the offsite package computer 567, it reports to the update agent 508 that it can reach the resource and estimates the time the retrieval will take. This estimate informs the agent how long it should wait before the requested resource is available. If the calculation estimation is not exact, as it probably will not be because of internet traffic fluctuations and server response time variances, then if the agent asks for the resource again the update server will provide another wait time length and the agent will wait once again. This cycle will repeat until the update server 528 has the resource available in memory and can deliver it to the agent upon the next request.

As a particular software package could be requested multiple times by different agents 508, in one implementation of the invention, the update server 528 will store this resource in a local cache 530 from which it can fulfill additional retrieval requests. To prevent the update server 528 from filling up all its available memory with old software packages, one embodiment stores the number of times the package is accessed and the time of the latest access for the stored software package and estimates a “time to live” amount of time for that resource to stay in its cache. A separate task running in the update server 528 will check periodically for resources that have “outlived” their usefulness and recover the update host's storage resources by deleting the stored software package update from the cache 530.

In one embodiment the update server will make the packages available to the list of agents one at a time. If an agent 508 or an outcome finder 512 reports that the application of the patch failed, or if the patch puts the agent's target computer 500 in such a state that it can no longer communicate with the update server, then the update server will suspend the rollout automatically on the administrator's behalf. At this point, the administrator, or some other designated person can be notified 516 of the outcome.

An outcome finder 512 determines if the software package installation was successful and then communicates its finding to the update server 528. If the outcome is unsuccessful, as discussed above, a restorer 514 places the target computer in an acceptable non-updated state. The outcome finder 512 does not necessarily monitor only the actual software installation; rather it can be set up to watch uses of the software that was patched, the entire target computer, and/or computers that are networked to the target computer, for some designated period of time. The outcome finder can also have different levels of success. For instance, the installation itself (file copying) can be considered a low level of success, while the target computer not misbehaving for a period of time thereafter can be considered a higher level of success, with different actions taken according to the success level. Success or failure can then be monitored as described earlier, and installation retried, suspended, etc. as necessary.

Some embodiments store a backup 506, 534 of a target computer 500 or a portion thereof before installing the software package on the target computer 500. Sometimes the backup is stored 534 on the update server, sometimes on the target computer 506, 500 which is having its software updated, and sometimes it is stored offsite at a repository site 600. When the outcome finder 512 reports a problem with a software installation, the restorer 514 can use the backup 534 to return the target computer to a non-updated state.

In one embodiment of the invention, the update server 528 waits for a confirmation of a successful installation (by the outcome finder 512, or by another known or inventive contact method) before the next target computer 500 has the software location reference 538 to the package placed on its update list 536 at the update server 528. In a preferred embodiment, when an installation finishes, an administrator is notified 516 of the results by email 518, pager 520, voice mail 522, SNMP notification 568, instant messaging 570, fax or by some other means. If the installation failed, the specific machine that the installation failed on may be identified. In some embodiments, after a default or user-defined number of successful installations, the package is made available to more than one user at a time.

These update lists 536 facilitate the administrator's designation of pre-built packages, or custom built packages, to be delivered or rolled-out to managed workstations clients or servers, which we refer to as target computers 500. When these packages are to be made available, updates are scheduled by the administrator to be performed by the invention; this may automate a previous task requiring the administrator's visit to a client to install a patch or service pack.

The update agent 508 may be aware of the platform it is operating upon, and may be programmable or scriptable to perform actions on behalf of the administrator. In one implementation these features are exposed to the administrator through Package Builder wizards. A “software package” can be any combination of files, service packs, hotfixes, software installations and scripts. This presents an opportunity for the administration of remote machines, since almost anything that could be performed at a remote machine can be accomplished via the agent acting on behalf of the administrator.

One implementation of the invention allows scripts 562 to be run before (pre-install) and after (post-install) the package installation. An example of a pre-install script may be: (in pseudo-code)

check for available disk space

If disk space available greater than ValueX (where ValueX=room needed for install plus a buffer) then continue with installation.

Else, alert outside administration that an error has occurred, and terminate.

An example of an post-install script (again, in pseudo-code):

If install was successful, then notify an outside source that install successful.

If install was unsuccessful, then notify an outside source that install was unsuccessful.

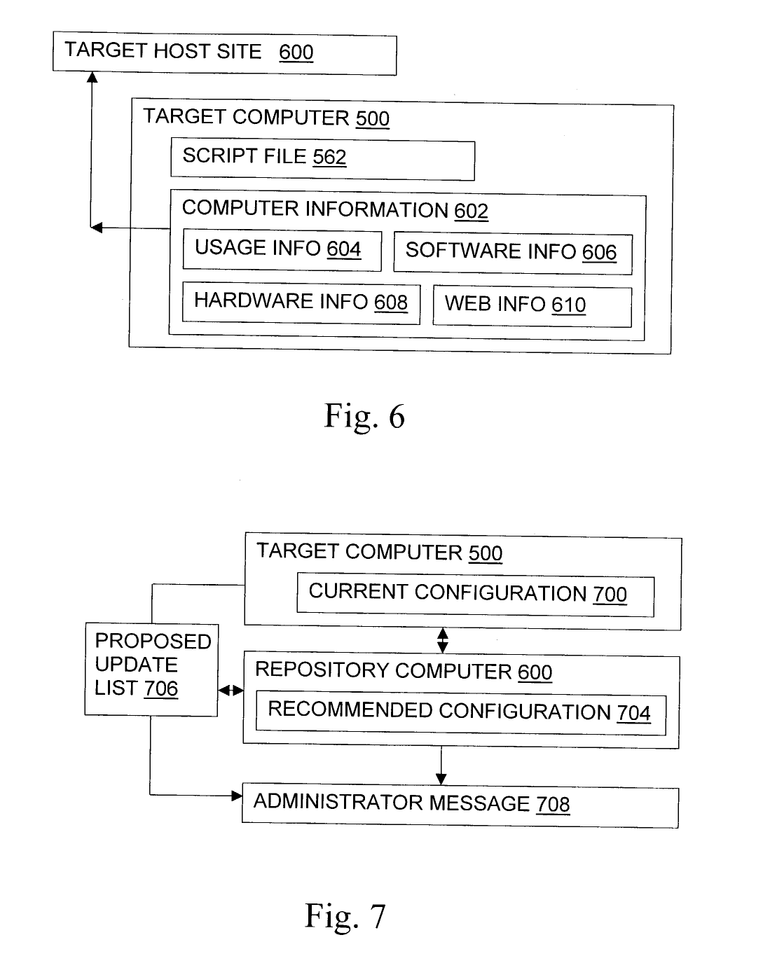

Referring now to FIGS. 6 and 7, the network 200 may include many different sorts of target computers, each with an agent that may be specifically constructed for the specific target platform. For example, a network running Microsoft Windows PCs, Apple Macintosh computers, and UNIX computers, may have three types of agents. This provides a benefit in that the agent is capable of surveying its target computer and reporting this computer information 602 to the update server 528 and/or to a separate repository site 600 for storage. In some instances of the system, a discovery agent 548 is provided which performs the scan, as discussed elsewhere. In other instances the scan is performed by the update agent 508, or a downloaded script file 562. Hardware configurations 608, software configurations 606, information about the usage of various hardware and software components 604, web sites visited, emails sent and received 610, can all be sent to the offsite location 600. Once this information is available at the update server, an administrator can view the entire managed network from one place.

When the inventive system is implemented on an existing network, the discovery agent 548 may perform a survey of the software in existence at least on the target computer 500, with existing software configurations 700 detected and stored within the repository site 600 memory. Some systems may survey the entire network 200. When updates are called for, the system knows which ones are needed without needing to resurvey the network machines to check their current status.

A recommended configuration 704 for the target computer 500 is placed on the update server 528 or on the repository site 600. The recommended configuration may be decided on in many ways, either inventive or known to those of skill in the database arts, for example, by hardware configuration, by software configuration, by type of computer, by last package update, and so on. The discovery agent 548 then compares the current 700 and recommended 704 configurations and prepares a proposed list of updates 708 for the target computer 500. The update list may include service packs for installed software, previously uninstalled software, updated data files, and the like. The process of preparing the suggested list may take into account not only the current software configuration but also information such as the hardware configuration 608, and how often a particular program, data file, etc. is accessed 604, as well as other information that is known to one of skill in the art. An administrator may be automatically notified of the update list.

Assuming that the target computer current configuration 700 generates a proposed update list 706, an administrator may be automatically notified 708. At this point, the computer use may be restricted until the new target computer is updated at least partially, until the administrator gives permission, or until some other inventive or known condition is met. This proposed update list 706 may also be used to define an update list 536 used to actually update the computer, as explained elsewhere.

Packages are composed of modules representing files, e.g., software files or data files, and scripts, which are sequences of actions to take upon files in the package. Alternatively one or more script file(s) may be included within the package content, and executed by the agent in order to install the patch. In some embodiments of the invention, a human administrator receives notice of the availability of new software patches. In other embodiments, the notices are sent directly to the offsite update server 528 which decides when to roll them out. The offsite update server can be configured to store in permanent memory the packages that have already been stored on each target computer. When a new package becomes available, or during the installation of an existing package, existing evidence of the software packages that need to be installed, as well as information about previous installations, is available in some embodiments at the offsite update server 528, and in other instances at the repository site 600.

The packages that are to be updated do not need to be owned by the target computer 500 user to receive access to it. In one embodiment of the system, the software package is owned by a third party which leases the software to the user. In another embodiment, the software package is owned by the update server user who then leases and provides access to the software package to the target computer 500 user.

Security and Critical Patch Management, Features

The present invention provides tools and techniques for managing and distributing critical patches that resolve known security vulnerabilities and other stability issues or enhancements, etc. in various operating systems. Suitable operating systems include, without limitation, all Microsoft operating systems (e.g., 95, 98, ME, NT, W2K, XP, .W2K3), UNIX operating systems (e.g., Linux, Solaris, AIX, HP-UX, SCO, etc), and Novell NetWare operating systems. Operating system product names are the marks of their respective owners.

In the past, in order to manage security or otherwise critical patches, corporations and other computer users have frequently checked vendor web sites, e.g., by reading news reports or textual alerts posted around the world wide web or were sent notifications via email subscription or newsgroup etc, to find out about new patches. Upon learning that a vendor whose software is used by the corporation has released a new patch to fix or enhance application software, driver software, and/or hardware, the corporation's software administrative personnel have generally had to manually download the latest relevant patches, test them for compatibility with the corporation's machines in various layouts and configurations, and then distribute the patch(es) manually or using their traditional software distribution tools.

By contrast, the present invention can provide notification 824 of critical updates to computers in a proactive manner, whether or not they have Internet access. It can operate proactively by performing patch downloads without requiring an express administrator command to perform each download. It can also assist with distribution and installation of software updates, software packages, and other data to networked desktop, server, mobile, and other computers.

One embodiment of the present invention includes content replication through an update server 528 that retrieves the latest critical updates from a master archive such as a package computer 567. Retrieval may use 128-bit SSL or other familiar protocols for secure transmission. As new updates are added to the master archive, the updates' metadata are downloaded automatically to the update servers and/or the fingerprint library 904. If metadata indicates a patch is critical, the patch can be downloaded to the update server and cached there for rapid deployment. Each patch has an associated installer 912, prerequisite signature 910, and other fingerprint identification 906.

In some embodiments information is sent in one direction only, namely, from the master archive to the update server, thereby enhancing security of the master archive. In addition, in some embodiments all transmitted information is encrypted, CRC (cyclic redundancy code) checked, compressed, digitally signed, and downloaded 308 over a 128-bit SSL connection. The SSL connection employs a secure network protocol that validates and confirms the authenticity of the master archive as the patch source. Other secure network protocols may also be used. In other embodiments, some of these elements are omitted, e.g., no CRC check is done and/or no digital signature is used, etc.

The update server 528 acts as the patch source for client target computers 500. The update server, which contains the replication service and administrative tools for managing updates and software packages, can scan clients 500 and schedule patch deliveries to them using protocols such as HTTP, HTTPS, and XML. In some embodiments, the update server uses Microsoft's Internet Information Services. The update server can be implemented to automatically cache critical updates it receives from the master archive. In some embodiments the administrator can set a replication schedule, can trigger replication manually, or can have the replication software in the update server replicate and distribute software automatically in response to expected or measured network inactivity.

In some embodiments, administrators can create software packages 554, which they can then deploy like any other patch. That is, a “patch” in the general sense need not presuppose a previously installed close-related piece of software that is being modified, but may comprise a piece of software new to the target. For example, a package containing Microsoft Office 2000 could be deployed to every desktop. Administrators of custom applications can similarly create packages to rollout custom applications and their patches. Some embodiment administrators may also utilize built-in software distribution features to distribute any software packages to any target computer.

In some embodiments the update server 528 is configured with software and/or hardware which displays an enterprise report matrix or other summary of the patch status of the machines in a corporation or other enterprise. The report is displayed to a network administrator and/or other personnel charged with maintaining the enterprise's computer functionality. The administrator influences (and in some cases totally controls) which updates or packages from the update server are pushed to the clients 500, by setting policies, defining groups, responding to alerts, and/or taking other steps which are discussed here or already familiar. In some embodiments the administrator has full control over the deployment of patches, including control of reboots and the power to set or modify client agent policies.

Patches may be tested internally before they are widely deployed through the enterprise, since a given patch may behave differently in different enterprises. PatchLink.com Corporation (“PatchLink”), which provides commercial software and services for patch management, and which is the assignee of this application and its ancestors, continually researches, tests, and approves patches before they are released by PatchLink. For instance, when a hot fix for the Microsoft W2K (Windows 2000) operating system is released by Microsoft, it may then be installed and tested by PatchLink on two hundred or more different W2K configurations, such as standard W2K, W2K with SQL server, W2K with Office, and W2K with Exchange (marks of Microsoft), and so on, in combination with various service packs and other hot fixes, before it is released by PatchLink to a master archive 567.

In some embodiments, the client agent 508 checks 332 an intranet-hosted update server to determine which updates are needed at the client in question. It reports gathered information, such as the current configuration 700, back to the update server, which creates the report matrix for the administrator. In some embodiments, the administrator specifies and approves patch deployment using a deployment wizard. Administrator-approved updates and packages are downloaded 312 in the background, thereby reducing inconvenience to users of the computers receiving the download, and then auto-installed according to a schedule set by the administrator. Administrator-defined rules can control the behavior of the patch install process.

One embodiment of the present invention provides a proactive service that enables administrators to have the embodiment automatically download 308, 312 and install 510 software packages and updates, such as critical operating system fixes and security patches.

A built-in security feature of some embodiments of the invention uses digital security identification. Before installing 520 a downloaded update on a target 500, this feature verifies the digital certificate, CRC check, compression, and encryption on each file or package. On the update server 528, access to administrative pages and other controls is restricted to authorized administrators. In some embodiments, replication (downloading) of updates uses SSL and the embodiment checks the validity of downloads to the update server; if the SSL certificates do not properly identify a recognized source (e.g., PatchLink.com) then the download fails, and the server sends an email alert to the administrator. In some embodiments, all information in all downloads (master archive to update server, update server to target) is encrypted, CRC checked, compressed, digitally signed, and sent over 128-bit SSL connections only. In other embodiments, these elements are amended (e.g., 40-bit encryption) and/or omitted.

A patch signature 910 feature permits an embodiment to scan the target 500 and determine if the prerequisite(s) for each patch have been met, e.g., by having the agent check for the proper software version and the proper hardware drivers on the target. The patch signature and the patch fingerprinting features may each be used to make a detection report which is viewable in an enterprise report matrix. A workstation inventory feature uses a discovery agent 508 to pinpoint the needed software and hardware drivers for a target computer. The discovery agent may also scan the target for necessary signatures for fingerprints. PatchLink.com has a master archive which now hosts one of the largest automated patch Fingerprinted repositories in the world.

A background download 312 feature in some embodiments provides a secure background transfer service with built-in bandwidth throttling, so the network administrator can decide how the bandwidth should be utilized during large deployments. Some embodiments provide administrators with a configurable agent 508 policy which permits them to define the agent's communication interval and operating hours. For instance, an administrator may set the policy to roll out patches to production servers only between midnight and 2:00 am. In some cases, agents may have more than one policy active at a given time.

A chained installation feature allows an administrator to reduce or minimize repetitive rebooting by using the Microsoft Qchain.exe tool. If multiple updates which require multiple reboots are to be installed 510, the administrator can use the present invention's capabilities in conjunction with Qchain to deploy the updates with fewer reboots; in some cases only a single reboot will be needed. This reduction in reboots increases the uptime of mission critical computers 500 that are being updated. Qchain rearranges the DLLs into an order that will put the latest update in effect. Administrators can choose this option during deployment.

Using a download resumption feature, an embodiment detects interruption 316 of a download, e.g., by a service outage. If the target 500 is a mobile workstation, the user can then simply disconnect it and reconnect it at a different location that is not out of service. If the update server can be accessed (via TCP/IP, for instance), the embodiment will resume its download 312 from at or near the point in the download at which it was interrupted, instead of starting again from the beginning to retransmit the entire package.

A mobile-user support feature allows administrators to deploy patches and software updates to target computers 500 which are not connected to the network when the deployment begins. When a mobile target subsequently connects to the network, the embodiment will automatically scan it and perform the necessary operations to bring that target up to date.

Embodiments feature client agents 508 which communicate with the update server 528 for secure downloads 312. Using agents also permits increased performance and scalability in enterprise-wide embodiments, permitting a single update server to service thousands of clients. The agents can work across firewalls 116, 214, and operate on any computer 500 with a TCP/IP (or other) connection to the enterprise network.

Some embodiments feature support for multi-vendor patches 554, which may also be referred to as “comprehensive patch scanning”. The update server 528 is not limited to patches from a single vendor, but instead supports inventive management of patches from multiple vendors. For instance, the update server may coordinate with target agents to scan targets 500 for patch-related security vulnerabilities in software from Microsoft, IBM, Adobe, Corel, Symantec, McAfee, Compaq, WinZip, Citrix, Novell, and many others (marks of the respective companies). This provides a more secure network.

A grouping feature of some embodiments allows administrators to group selected target computers 500 into sets called, e.g., “containers” or “groups”. Operations that are applicable to an individual target computer can then also be applied to containers/groups holding a proper subset of the possible target computers, namely, to every target computer 500 (or every suitable target computer in view of patch signatures and fingerprints) belonging to the specified container. This feature facilitates administrator management of deployments, fingerprint reporting, inventory reporting, mandatory patch baseline policy, and/or client agent policies, depending on the embodiment. For instance, each container may have properties that specify its members, its client agent 508 policies, and its mandatory patch baseline policy. Administrators can select individual clients 500, previously-defined client groups, and/or user-defined groups for deployment. In some embodiments computers can be automatically grouped according to the patch(es) they require.

In some embodiments, the administrator can specify Group Managers and delegate limited administrative control to them. From the Group Manager perspective, the view and control of the inventive embodiment is then narrowed to cover only those computers 500 that have been assigned to the managed group by the administrator, all of which preferably use the same update server 528. The administrator can still view and otherwise manage all computers in the network, not merely those in a particular group.

A mandatory patch baseline policy feature in some embodiments permits an administrator to specify a minimal (baseline) configuration for one or more of a network's computers. The embodiment will proactively patch operating systems and/or applications to the organizational standards defined by the baseline policy. Supporting patch policies in an enterprise allows the administrator of an inventive embodiment to set patch policies for his/her company whereby no machine 500 in the company, for instance, can fall below a minimum patch level. For example, if mandatory patch baseline policy for a W2K group includes Microsoft Office 2000, Adobe Acrobat Reader 5.0, and Service Pack 2, then all computers placed in this group (whether placed initially on group definition, or placed later) will have at least those pieces of software installed on them.

A baseline for patches may be associated with a set of computers 500 that is defined by a group (e.g., a user-defined group or an administrator-defined group), or with a set of computers 500 that use a particular operating system (e.g., all W2K computers, regardless of user-or-administrator-defined groups), or with a set of computers 500 that use a particular application (e.g., all computers that use Microsoft Office XP), or with some combination thereof. For example, in some embodiments the administrator could set a baseline policy rule stating that if Microsoft Office XP is installed then the system should automatically patch in Office XP Service Release 1.

When a mandatory patch baseline policy is used, patches 554 that are dropped (removed) from a target 500 by restoring software from a tape backup, mirrored image, or the like, will be automatically reinstalled after the agent 508 determines the new configuration and that configuration is compared 822 (by the client agent and/or the update server) with the baseline required by the policy. Baseline integrity is thus maintained by these embodiments.

A mandatory patch baseline policy can be used according to the invention to perform automated detection of unwanted software and removal of that unwanted software from target computers within a network. The mandatory deployment patch to be applied when unwanted software is detected would be to UNINSTALL the unwanted items. For example, one such patch would be “Uninstall KaZaA” which would detect and remove the KaZaA file sharing application from a corporate network, thereby reducing the risk that corporate employees violate copyright laws during the course of the business day, or that they consume all available network bandwidth for entertainment purposes. With government agencies and other large entities, eliminating popup software and other things that distract users from their assigned duties can be a high priority.

The invention also provides a feature that may be viewed as the logical opposite of mandatory patching to cure vulnerabilities in a network. This logical opposite, which may be termed the “Forbidden Patch” feature, is used to denote a service pack, hotfix or other software that must not ever be installed. Just as the mandatory patch feature is used to auto-fix a vulnerability, the forbidden patch feature is used to prevent the network administrator from installing software that can break an operational configuration. As an example, assume a company has a payroll system that doesn't work with the latest Microsoft Service Pack for Windows2000. If that Service Pack patch is ever deployed manually or automatically to the payroll server(s), the administrator needs to know at once; otherwise nobody gets paid at the end of the week. Some embodiments of the can scan for and detect the presence of “forbidden patches” and alert the administrator. They may also provide rules so that an administrator does not inadvertently deploy a forbidden patch to a machine that should not have that patch installed, regardless of whether the applicable group patching policies say otherwise.

A patch compliance assurance feature in some embodiments provides administrators with the option of locking a set of patches 554 for a particular computer or a group of computers 500. That is, certain patches are required, but in a manner weaker than in the mandatory baseline feature. If an attempt is made to change target 500 configuration in a way that violates the patch requirement, an email alert message 824 is sent to the administrator. For example, several W2K computers may belong to an administrator-defined group of “IIS Servers” which is subject to patch compliance. For security, the embodiment accordingly locks down all operating system patches and all Internet Information Server patches. If at some later point such patches (including without limitation DLLs) are replaced, then the embodiment will send an email alert to the administrator identifying the computer 500 name and/or the modifications done to it. The newly non-compliant computer(s) and the reason(s) for non-compliance—a summary of discrepancies between their configuration and the locked configuration—can be identified. In some cases, this compliance feature may be used by administrators to identify users who install new software or remove existing software from their machine. Note that this compliance locking feature may be used by some embodiments in conjunction with the mandatory patch baseline feature, to automatically patch a target 500 that is non-compliant. When a locked patch or other software component is removed, it is then automatically reinstalled, and the administrator is notified 824 by email.

A service change feature in some embodiments allows administrators to lock down the services provided at client workstations (residing in a group or individually), and to then be informed if a user starts or stops a service item without directly contacting the administrator. As users change and/or attempt to change the status of services on a locked client 500, an email alert 824 is sent to the administrator identifying the computer and the (attempted) service changes.

A hardware change feature in some embodiments allows administrators to lock down the hardware configuration provided at client workstations 500 (e.g., in a group), and to then be informed if a user installs or removes a hardware item from such a workstation without directly contacting the administrator. As users change (or attempt to change) the hardware configuration on a locked client, an email alert is sent 824 to the administrator identifying the computer and the (attempted) hardware changes.

An import/export feature facilitates the updating of computers on networks that are not connected to the Internet, such as highly secure military or government agency computers. Content is transported from the master archive to the target network's update server 528 using a means other than the Internet, such as physically transporting tapes, disks, or other storage media loaded with the content 554 at the master archive, with suitable physical security measures taken during transport. Once the media is accessible to the secure target network's update server 528, the built-in security measures discussed above (encryption, CRC, etc.) can be employed while transmitting the content from the transported media to local storage of that update server. Then that update server can finish updating 304 the secure network's target computers as previously discussed.

A recurring distribution feature in some embodiments facilitates distribution of data or documents 554 that are repeatedly updated, such as an enterprise employee directory or anti-virus definition/data file. One or more such data or document files can be deployed according to a recurring schedule specified by the administrator, to all targets 500, for instance, or to administrator-specified groups or a single target. Other steps, such as recurring server reboots, may also be specified in some cases.

A disaster recovery feature of some embodiments helps administrators recover from system failures such as hard disk crashes or server hardware failures. If an update server 528 fails, the administrator creates another server having the same DNS name as the failed server, and reinstalls the same update server software (with the same serial number if so required) on the new server. Archived, mirrored, or otherwise stored data files 600 used by the embodiment are restored to the new update server as needed. Then the target agents 508 will automatically connect with the new instance of the update server, and normal operations will resume after the target agents provide information (if any) that was lost by the server failure.

An automatic caching feature in some embodiments causes the update server 528 to automatically download and cache in its local update server storage patches 554 that are marked as critical, high-priority, and/or security-related. The update server notifies the administrator as to which patches are critical and which are cached, and scans for target computers 500 that need the patch. By contrast, non-critical patches may be cached at the update server only after they are first deployed. Caching the critical and security patches before their initial deployment provides target computers with a readily available source for the patch when the vendor whose software is vulnerable may be overwhelmed by patch requests. During Code Red and Nimda virus attacks, for instance, some users had to wait hours for a connection to the Microsoft web site to get the patches, because of the extremely heavy demand for them. Proactively caching critical and security patches at an inventive update server 528 reduces the risk that operation of target computers 500 will be interrupted or compromised due to a lack of such patches.

Some embodiments have an intelligent multiple patch deployment feature, which matches patches 554 with operating systems, thereby relieving administrators of the need to expressly and fully identify the operating system used on each target computer. For example, assume Microsoft issued a bulletin for its operating systems which specifies different patches 554 for several different operating system platforms. Administrators using this inventive embodiment need only select “Microsoft operating system” for deployment; they can specify target computers 500 regardless of differences in the operating system details of various specified targets. The embodiment compares 820 patch and operating system requirements for compatibility and for the need for a patch, to ensure that the proper patch gets installed on a given target. Thus, the patch for the Microsoft Windows 98 platform will be installed on a target computer that runs the Windows 98 operating system, the patch for the Microsoft NT platform will be installed on a target computer that runs the NT operating system, and so on. This feature speeds up patch deployment by freeing administrators from the need to manually match patches with targets according to the operating systems (or operating system versions, including prior patches) that are involved.

Another feature helps detect applicable patches 554 and manage patch interdependencies, thereby helping administrators avoid manually sorting through dozens (or even hundreds) of generally unrelated patches. Instead, the embodiment identifies applicable patches using their metadata, fingerprint, and/or signature data, based on factors such as the operating system involved, the presence (or absence) of other patches, the interdependency of different patches (identifying which patches rely on which other patches to work properly), and the mandatory patch baseline policy (if any). Then the administrator is shown which patches are applicable for the target(s) 500 in question. For example, one embodiment shows IIS patches to administrators only if IIS is installed on a target computer. If used consistently, this feature helps ensure that when a patch is deployed toward a target, that target has the application in question and the patch will install on that target.

As an example of patch interdependencies, on a Microsoft W2K platform one embodiment will recommend Service Pack 2 to the administrator, and once Service Pack 2 is installed it will then recommend a Security Rollup patch, which depends on Service Pack 2. The embodiment reads both the registry and the file information to correctly perform fingerprinting to validate patch 554 identification.

Some embodiments allow an administrator to review a history or log of recent operations, and to also uninstall a patch 554 or portion thereof, and rollback effects of deploying the patch to the network. This allows the administrator to undo a patch installation that has caused problems. Lost user data will not necessarily be recovered, but the usual steps taken by a conventional uninstaller can be taken using a restorer 514, such as deleting a DLL, removing a registry entry, restoring a path or other system variable value, and so forth. In addition, the configuration status particular to the embodiment, such as signatures, fingerprints, alerts, and reports, is updated to reflect the problems encountered and/or the removal of the patch. The administrator can also be notified if the removed patch appears in a patch dependency and/or in the mandatory patch baseline.

Some embodiments have a “directory-neutral” feature, meaning that they are platform neutral and do not require a directory such as Novell's NDS directory or Microsoft's Active Directory product in order to operate. However, some embodiments can integrate with and cooperate with such directories in particular organizations.

Some embodiments operate according to a selective patch feature, under which patches 554 are not automatically installed unless they are required to meet the mandatory patch baseline policy. In some, patches marked as critical and/or security patches are also installed automatically. In such embodiments, other patches are not installed until they administrator selects them and expressly authorizes their installation; this permits administrators to test patches internally within their organization before installing them on the organization's computers. Once the patch is adequately tested, it can be added to the mandatory patch baseline for the group of targets 500 in question, so that it will be automatically installed when needed.

Some embodiments support a security policy patch 554 that prevents applications from running on a target machine 500. This provides a policy-driven way to hook into the target computer's file system and stop a particular file (or multiple files) from executing. This could be implemented by patches that rename the executable/DLL file(s) in question and substitute in place thereof code that does nothing, or code that displays an error message to the user, and/or code that notifies the administrator by email.

Operation of inventive embodiments may be further understood by considering the following example scenarios. In one scenario, as new patches 554 are released by their respective vendors, an update server 528 downloads the corresponding fingerprints from a master archive 567. The embodiment then checks to see if any target computers 500 meet the profile (need the patch in question) by sending the patch's fingerprint to targets for scanning by agents 508. The administrator is notified of the new patch and its potential impact on the network, and a report matrix informs the administrator which targets need the patch and which do not. The administrator selects one or more individual target computers and/or groups, and authorizes deployment. Deployment proceeds as discussed herein. The administrator may set the time of deployment, and decide whether to reboot after the installation.

In a managed data center scenario, the center's administrator creates a patch group from each cluster of data servers. The administrator can test critical updates received from a master archive 567, and then deploy tested patches 554 on network targets, either all at once, or in stages to groups. Agent policies can help the administrator specify the hours of operation for each group.

In an embodiment update scenario, the software used by the embodiment is updated by using the embodiment. That is, when a vendor (such as PatchLink.com) provides patches 554 to the software for target agents 508, update servers 528, and/or other embodiment software, those patches can be deployed as discussed herein, using the inventive tools and techniques that would more often be used to deploy patches to operating systems or user applications. For instance, an administrator can select a PatchLink HotFix client patch and deploy it to update client agent software. Client agents may be initially deployed by pushing them to all target computers.

Implementation Notes

Additional details regarding particular embodiments are provided below. These implementation details are provided in order to err—if errors are made—by including too much information rather than including too little. Applicants should not be penalized for being so forthcoming. In particular, the inclusion of details should not be viewed as an assumption or admission that those details, or similar details, or a similar level of detail, are actually required to support the claims ultimately granted. Nor should the inclusion of particular implementation details be misinterpreted by treating as inventors people who simply implemented inventive ideas conceived by others.

[image]

[image]

[image]

[image]

[image]

[image]

[image]

[image]

[image]

[image]

[image]

[image]

[image]

[image]

[image]

### SUMMARY

The invention provides systems, methods, and configured storage media for assuring that software updates are needed, and that the computers have the necessary software and hardware components, then updating the software across a network with little or no need for human oversight, without requiring copies of the software patches on an administrative machine on the network whose clients are being updated, and which removes the updates from the affected machines, leaving them in a usable state when a problem is discovered during installation or after installation with an installed patch.

As used herein, terms such as “a” and “the” and item designations such as “update server” are inclusive of one or more of the indicated item. In particular, in the claims a reference to an item means at least one such item is required. When exactly one item is intended, this document will state that requirement expressly.

The invention may be embodied in other specific forms without departing from its essential characteristics. The described embodiments are to be considered in all respects only as illustrative and not restrictive. Headings are for convenience only. The claims are part of the specification which describes the invention. The scope of the invention is, therefore, indicated by the appended claims rather than by the foregoing description. All changes which come within the meaning and range of equivalency of the claims are to be embraced within their scope.

What is claimed and desired to be secured by patent is:

1. An automated method for updating software in a system having a first target computer in a non-update state connected across a network to an update server in a pre-update state, the system also having a package computer which may be inaccessible to the first target computer and is accessible to the update server, and a repository component accessible to the first target computer and the update server, the method comprising the steps of:
putting at least one patch fingerprint which defines a specific software update into the repository component;
gathering information about the first target computer;
comparing at least a portion of the gathered information with the patch fingerprint to determine if the specific software update is absent from the target computer;
placing at least one task identifier on an update task list, the task identifier specifying the first target computer, the task identifier also specifying at least one download address which references a location on the package computer that contains a software update for the first target computer;
in response to the task identifier, downloading the software update from the package computer to the update server; and
performing a second download of the software update from the update server to the first target computer.

2. The method of claim 1, further comprising the step of providing a patch definition file which is portable and which can be employed to replicate a patch on update servers in a plurality of networks.

3. The method of claim 1, wherein the method operates proactively by performing the download steps without requiring an express administrator command to perform them.

4. The method of claim 1, wherein the method operates proactively by caching a marked patch at the update server before deploying the patch to target computers, the patch marked as at least one of critical, high-priority, and security-related.

5. The method of claim 1, further comprising at least two steps from the following group of security steps: utilizing encryption to secure patch downloads; utilizing cyclic redundancy codes to secure patch downloads; utilizing digital signatures to secure patch downloads; utilizing a secure network protocol such as SSL to secure patch downloads, wherein at least one of the security steps is available in the particular method embodiment.

6. The method of claim 1, wherein the step of downloading the software update from the update server to the first target computer is performed using a background downloading process, thereby reducing inconvenience to a user of the first target computer.

7. The method of claim 1, wherein the step of downloading the software update from the update server to the first target computer is performed using bandwidth-throttled downloading, thereby allowing a network administrator to decide how bandwidth should be employed during a large deployment.

8. The method of claim 1, wherein downloading is performed subject to a policy which limits the hours of operation, and the policy is set by an administrator, thereby allowing the administrator to decide when patch deployments are allowed to occur.

9. The method of claim 1, further comprising preventing downloads of software updates from the update server to the package computer, thereby enhancing security of the package computer.

10. The method of claim 1, wherein the method further comprises use of a chained installation feature permitting an administrator to have downloaded patches installed on the target computer with fewer reboots than would otherwise be required.

11. The method of claim 1, wherein the method further comprises use of a download resumption feature which detects interruption of a downloading step and then after a reconnection resumes the downloading step from at or near the point in that downloading step at which the interruption occurred, thereby avoiding repetition of the entire downloading step to achieve the download.

12. The method of claim 1, wherein the method further comprises use of a mobile-user support feature which allows an administrator to deploy a patch to the first target computer even though the first target computer is not connected to the network when the task identifier placing step occurs.

13. The method of claim 1, wherein the method comprises downloading multiple patches which originated from multiple vendors.

14. The method of claim 1, wherein the method further comprises the step of grouping a proper subset of target computers to form a group, whereby an operation that is applicable to an individual target computer can also be applied to the group.

15. The method of claim 14, wherein the grouping step forms a group containing target computers that are specified by an administrator.

16. The method of claim 14, wherein the grouping step forms a group containing target computers that are specified by a non-administrative user.

17. The method of claim 14, wherein the grouping step forms a group containing target computers that are specified by identifying an operating system that is used by all of the target computers which are being placed in the group.

18. The method of claim 14, wherein the grouping step forms a group containing target computers that are specified by identifying an application program that is used by all of the target computers which are being placed in the group.

19. The method of claim 14, wherein the method further comprises the step of delegating limited administrative control to a group manager, whereby the group manager receives control over only those target computers that were placed in the group by the grouping step.

20. The method of claim 1, wherein the method further comprises use of a mandatory patch baseline policy which specifies at least in part software that should be installed on the first target computer, and the method proactively downloads and installs on the first target computer a patch that is specified in the mandatory patch baseline policy.

21. The method of claim 20, wherein the mandatory patch baseline policy sets a baseline for target computers that use a particular application.

22. The method of claim 20, wherein the mandatory patch baseline policy mandates removal of unwanted software from a target computer.

23. The method of claim 1, wherein the method further comprises use of a forbidden patch feature which specifies software that should not be installed on the first target computer, and the method attempts to prevent such installation from occurring.

24. The method of claim 20, wherein the method further comprises automatically reinstalling a patch that is specified in the mandatory patch baseline policy after software in the patch was dropped from a target computer that is subject to the mandatory patch baseline policy.

25. The method of claim 1, wherein the method further comprises the steps of grouping a proper subset of target computers to form a group, and using a mandatory patch baseline policy to specify at least in part software that should be installed on the target computers in the group.

26. The method of claim 1, wherein the method further comprises use of a patch compliance assurance feature which specifies software that is locked on the first target computer, and the method proactively notifies an administrator if locked software is removed from the first target computer.

27. The method of claim 1, wherein the method further comprises use of a change control feature which specifies at least one item that is locked on the target computer, and the method proactively notifies an administrator if a locked item is changed on the target computer, wherein the item is at least one of: a hardware item, a service item, and a software item.

28. The method of claim 1, wherein at least the step of downloading the software update from the update server to the first target computer recurs, thereby repeatedly updating a particular file on at least the first target computer.

29. The method of claim 1, further comprising at least one step from a group of disaster recovery steps, the step helping an administrator recover and continue operation after a system failure, wherein the group of disaster recovery steps comprises: creating another server with the same domain name as a failed server, reinstalling update server software on a server, restoring archived data, and restoring mirrored data, and wherein at least one of the disaster recovery steps is available in the particular method embodiment.

30. The method of claim 1, further comprising the steps of maintaining a record of recent operations, and rolling back deployment of a patch, thereby allowing an administrator to undo a target computer patch installation that has caused problems.

31. The method of claim 1, wherein the method further comprises use of a intelligent multiple patch deployment feature which matches patches with target computer operating systems, thereby relieving an administrator of the need to expressly and fully identify the operating system used on the target computer.

32. The method of claim 1, wherein the method installs a security patch on the first target computer, thereby providing an administrator with a policy-driven way to hook into the target computer's file system and stop at least one particular file from executing on the target computer.

33. A configured program storage medium having a configuration that represents data and instructions which will cause at least a portion of a computer system to perform method steps of an automated method for updating software in the system, the system having a first target computer in a non-update state connected across a network to an update server in a pre-update state, the system also having a package computer which may be inaccessible to the first target computer and is accessible to the update server, and a repository component accessible to the first target computer and the update server, the method comprising the steps of:
putting at least one patch fingerprint which defines a specific software update into the repository component;
gathering information about the first target computer;
comparing at least a portion of the gathered information with the patch fingerprint to determine if the specific software update is absent from the target computer;
placing at least one task identifier on an update task list, the task identifier specifying the first target computer, the task identifier also specifying at least one download address which references a location on the package computer that contains a software update for the first target computer;
in response to the task identifier, downloading the software update from the package computer to the update server; and
performing a second download of the software update from the update server to the first target computer.

34. The configured storage medium of claim 33, wherein the method further comprises the step of providing a patch definition file which is portable and which can be employed to replicate a patch on update servers in a plurality of networks.

35. The configured storage medium of claim 33, wherein the method operates proactively by performing the download steps without requiring an express administrator command to perform them.

36. The configured storage medium of claim 33, wherein the method operates proactively by caching a marked patch at the update server before deploying the patch to target computers, the patch marked as at least one of critical, high-priority, and security-related.

37. The configured storage medium of claim 33, wherein the method further comprises at least two steps from the following group of security steps: utilizing encryption to secure patch downloads; utilizing cyclic redundancy codes to secure patch downloads; utilizing digital signatures to secure patch downloads; utilizing a secure network protocol such as SSL to secure patch downloads, wherein at least one of the security steps is available in the particular method embodiment.

38. The configured storage medium of claim 33, wherein the step of downloading the software update from the update server to the first target computer is performed using a background downloading process, thereby reducing inconvenience to a user of the first target computer.

39. The configured storage medium of claim 33, wherein the step of downloading the software update from the update server to the first target computer is performed using bandwidth-throttled downloading, thereby allowing a network administrator to decide how bandwidth should be employed during a large deployment.

40. The configured storage medium of claim 33, wherein downloading is performed subject to a policy which limits the hours of operation, and the policy is set by an administrator, thereby allowing the administrator to decide when patch deployments are allowed to occur.

41. The configured storage medium of claim 33, wherein the method further comprises preventing downloads of software updates from the update server to the package computer, thereby enhancing security of the package computer.

42. The configured storage medium of claim 33, wherein the method further comprises use of a chained installation feature permitting an administrator to have downloaded patches installed on the target computer with fewer reboots than would otherwise be required.

43. The configured storage medium of claim 33, wherein the method further comprises use of a download resumption feature which detects interruption of a downloading step and then after a reconnection resumes the downloading step from at or near the point in that downloading step at which the interruption occurred, thereby avoiding repetition of the entire downloading step to achieve the download.

44. The configured storage medium of claim 33, wherein the method further comprises use of a mobile-user support feature which allows an administrator to deploy a patch to the first target computer even though the first target computer is not connected to the network when the task identifier placing step occurs.

45. The configured storage medium of claim 33, wherein the method comprises downloading multiple patches which originated from multiple vendors.

46. The configured storage medium of claim 33, wherein the method further comprises the step of grouping a proper subset of target computers to form a group, whereby an operation that is applicable to an individual target computer can also be applied to the group.

47. The configured storage medium of claim 46, wherein the grouping step forms a group containing target computers that are specified by an administrator.

48. The configured storage medium of claim 46, wherein the grouping step forms a group containing target computers that are specified by a non-administrative user.

49. The configured storage medium of claim 46, wherein the grouping step forms a group containing target computers that are specified by identifying an operating system that is used by all of the target computers which are being placed in the group.

50. The configured storage medium of claim 46, wherein the grouping step forms a group containing target computers that are specified by identifying an application program that is used by all of the target computers which are being placed in the group.

51. The configured storage medium of claim 46, wherein the method further comprises the step of delegating limited administrative control to a group manager, whereby the group manager receives control over only those target computers that were placed in the group by the grouping step.

52. The configured storage medium of claim 33, wherein the method further comprises use of a mandatory patch baseline policy which specifies at least in part software that should be installed on the first target computer, and the method proactively downloads and installs on the first target computer a patch that is specified in the mandatory patch baseline policy.

53. The configured storage medium of claim 52, wherein the mandatory patch baseline policy sets a baseline for target computers that use a particular application.

54. The configured storage medium of claim 52, wherein the method further comprises automatically reinstalling a patch that is specified in the mandatory patch baseline policy after software in the patch was dropped from a target computer that is subject to the mandatory patch baseline policy.

55. The configured storage medium of claim 33, wherein the method further comprises the steps of grouping a proper subset of target computers to form a group, and using a mandatory patch baseline policy to specify at least in part software that should be installed on the target computers in the group.

56. The configured storage medium of claim 33, wherein the method further comprises use of a patch compliance assurance feature which specifies software that is locked on the first target computer, and the method proactively notifies an administrator if locked software is removed from the first target computer.

57. The configured storage medium of claim 33, wherein the method further comprises use of a change control feature which specifies at least one item that is locked on the target computer, and the method proactively notifies an administrator if a locked item is changed on the target computer, wherein the item is at least one of: a hardware item, a service item, and a software item.

58. The configured storage medium of claim 33, wherein at least the step of downloading the software update from the update server to the first target computer recurs, thereby repeatedly updating a particular file on at least the first target computer.

59. The configured storage medium of claim 33, wherein the method further comprises at least one step from a group of disaster recovery steps, the step helping an administrator recover and continue operation after a system failure, wherein the group of disaster recovery steps comprises: creating another server with the same domain name as a failed server, reinstalling update server software on a server, restoring archived data, and restoring mirrored data, and wherein at least one of the disaster recovery steps is available in the particular method embodiment.

60. The configured storage medium of claim 33, wherein the method further comprises the steps of maintaining a record of recent operations, and rolling back deployment of a patch, thereby allowing an administrator to undo a target computer patch installation that has caused problems.

61. The configured storage medium of claim 33, wherein the method further comprises use of a intelligent multiple patch deployment feature which matches patches with target computer operating systems, thereby relieving an administrator of the need to expressly and fully identify the operating system used on the target computer.

62. The configured storage medium of claim 33, wherein the method installs a security patch on the first target computer, thereby providing an administrator with a policy-driven way to hook into the target computer's file system and stop at least one particular file from executing on the target computer.
